(19) United States
(12) Patent Application Publication
(10) Pub. No.: US 2023/0115663 A1
(43) Pub. Date: Apr. 13, 2023

(54) DUPLEX COMMUNICATIONS OVER BANDWIDTH PARTS

(71) Applicant: QUALCOMM Incorporated, San Diego, CA (US)

(72) Inventors: Ahmed Attia ABOTABL, San Diego, CA (US); Alexandros MANOLAKOS, Escondido, CA (US); Muhammad Sayed Khairy ABDELGHAFFAR, San Jose, CA (US)

(21) Appl. No.: 17/906,146

(22) PCT Filed: May 20, 2021
(86) PCT No.: PCT/US2021/033447

§ 371 Date: Sep. 12, 2022

(30) Foreign Application Priority Data
May 25, 2020 (GR) 20200100278

(51) Int. Cl. H04W 72/0457; H04W 72/23

(52) U.S. Cl. CPC H04W 72/0457; H04W 72/23

(57) ABSTRACT

Methods, systems, and devices for wireless communications are described. A communication device, otherwise known as a user equipment (UE), may identify a set of resource bandwidths of a bandwidth part (BWP) based on a BWP configuration. The UE may, for example, receive the BWP configuration from a network (e.g., a base station in wireless communication with the UE). The UE may determine that at least one resource bandwidth of the set of resource bandwidths is a master resource bandwidth (also referred to as a default resource bandwidth). The UE may communicate with a base station using the master resource bandwidth of the set of resource bandwidths for the BWP. Alternatively, the UE may communicate with the base station using another resource bandwidth of the set of resource bandwidths for the BWP.

### CROSS REFERENCE

The present Application is a 371 national stage filing of International PCT Application No. PCT/US2021/033447 by ABOTABL et al. entitled “DUPLEX COMMUNICATIONS OVER BANDWIDTH PARTS,” filed May 20, 2021; and claims priority to Greece Provisional Patent Application No. 2020/0100278 by ABOTABL et al. entitled “DUPLEX COMMUNICATIONS OVER BANDWIDTH PARTS,” filed May 25, 2020, each of which is assigned to the assignee hereof, and each of which is expressly incorporated by reference in its entirety herein.

### FIELD OF TECHNOLOGY

The following relates generally to wireless communications and more specifically to joint bandwidth part (BWP) and resource bandwidth indication.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FMDA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

Various aspects of the described techniques relate to configuring a communication device, which may be otherwise known as user equipment (UE) to support duplex communications over one or multiple bandwidth parts (BWPs) or sub-BWPs. A BWP or a sub-BWP may be referred to as a resource bandwidth and may include a portion of a radio frequency spectrum band that the UE may use for downlink communications, or uplink communications, or both. The UE may receive a BWP configuration defining a set of resource bandwidths for the one or multiple BWPs. Each resource bandwidth may define time and frequency resources associated with the one or multiple BWPs allocated for downlink communications or uplink communications. The resource bandwidths may thus accommodate disjoint bandwidth allocation for duplex communications, such as full-duplex communications supporting both downlink communications and uplink communications.

The UE may determine that at least one resource bandwidth in the set is a master resource bandwidth (e.g., which also be referred to as a default resource bandwidth) used for the downlink communications, or the uplink communications, or both. For example, the master resource bandwidth may function as a default resource bandwidth for the UE if the UE does not know which resource bandwidth to use for a BWP. The master resource bandwidth may also provide flexibility for the UE, for example, when switching BWPs such that the master resource bandwidth may become an active resource bandwidth unless the UE determines or is signaled (e.g., from a base station) a particular resource bandwidth. The described techniques may, as a result, include features for improvements to BWP operations when switching BWPs and, in some examples, may promote high reliability and low latency duplex communications over different BWPs in various system, such as 4G and 5G systems, among other benefits.

A method of wireless communication at a UE is described. The method may include identifying a set of resource bandwidths of a first BWP based on a BWP configuration, determining that at least one resource bandwidth of the set of resource bandwidths is a master resource bandwidth, and communicating with the base station using a resource bandwidth of the set of resource bandwidths for the first BWP based on the determining.

An apparatus for wireless communication is described. The apparatus may include a processor, memory coupled with the processor, and instructions stored in the memory. The instructions may be executable by the processor to cause the apparatus to identify a set of resource bandwidths of a first BWP based on a BWP configuration, determine that at least one resource bandwidth of the set of resource bandwidths is a master resource bandwidth, and communicate with the base station using a resource bandwidth of the set of resource bandwidths for the first BWP based on the determining.

Another apparatus for wireless communication is described. The apparatus may include means for identifying a set of resource bandwidths of a first BWP based on a BWP configuration, determining that at least one resource bandwidth of the set of resource bandwidths is a master resource bandwidth, and communicating with the base station using a resource bandwidth of the set of resource bandwidths for the first BWP based on the determining.

A non-transitory computer-readable medium storing code for wireless communication at a UE is described. The code may include instructions executable by a processor to identify a set of resource bandwidths of a first BWP based on a BWP configuration, determine that at least one resource bandwidth of the set of resource bandwidths is a master resource bandwidth, and communicate with the base station using a resource bandwidth of the set of resource bandwidths for the first BWP based on the determining.

In some examples of the method, apparatuses, and non-transitory computer-readable medium described herein, communicating with the base station may include operations, features, means, or instructions for communicating with the base station using the master resource bandwidth for the first BWP based on determining that the at least one resource bandwidth of the set of resource bandwidths may be the master resource bandwidth, where the resource bandwidth may be the master resource bandwidth.

Some examples of the method, apparatuses, and non-transitory computer-readable medium described herein may further include operations, features, means, or instructions for receiving an indication of the master resource bandwidth from the base station, where determining that the at least one resource bandwidth of the set of resource bandwidths may be the master resource bandwidth may be based on the indication.

In some examples of the method, apparatuses, and non-transitory computer-readable medium described herein, the receiving may include operations, features, means, or instructions for receiving one of a more of a radio resource control (RRC) message, a downlink control information (DCI) message, or a medium access control-control element (MAC-CE) message including the indication of the master resource bandwidth, where determining that the at least one resource bandwidth of the set of resource bandwidths may be the master resource bandwidth may be based on one or more of the RRC message, the DCI message, or the MAC-CE message including the indication.

In some examples of the method, apparatuses, and non-transitory computer-readable medium described herein, determining that the at least one resource bandwidth of the set of resource bandwidths may be the master resource bandwidth may include operations, features, means, or instructions for determining that the at least one resource bandwidth corresponds to a smallest resource bandwidth of the set of resource bandwidths.

In some examples of the method, apparatuses, and non-transitory computer-readable medium described herein, determining that the at least one resource bandwidth of the set of resource bandwidths may be the master resource bandwidth may include operations, features, means, or instructions for determining that the at least one resource bandwidth corresponds to a largest resource bandwidth of the set of resource bandwidths.

In some examples of the method, apparatuses, and non-transitory computer-readable medium described herein, the master resource bandwidth overlaps with an uplink band, a guard band, or a downlink band, or any combination thereof.

Some examples of the method, apparatuses, and non-transitory computer-readable medium described herein may further include operations, features, means, or instructions for switching from the first BWP to a second BWP for communicating with the base station, where communicating with the base station includes communicating with the base station based on switching to the second BWP.

Some examples of the method, apparatuses, and non-transitory computer-readable medium described herein may further include operations, features, means, or instructions for determining that the master resource bandwidth associated with the first BWP may be an active resource bandwidth for the second BWP based on a configuration, where communicating with the base station includes.

Some examples of the method, apparatuses, and non-transitory computer-readable medium described herein may further include operations, features, means, or instructions for determining an active resource bandwidth for the second BWP based on receiving an indication of the active resource bandwidth for the second BWP, where communicating with the base station includes.

In some examples of the method, apparatuses, and non-transitory computer-readable medium described herein, the active resource bandwidth associated with the second BWP may be different from the master resource bandwidth associated with the first BWP.

Some examples of the method, apparatuses, and non-transitory computer-readable medium described herein may further include operations, features, means, or instructions for receiving a DCI message from the base station, where switching to the second BWP may be based on the DCI message.

Some examples of the method, apparatuses, and non-transitory computer-readable medium described herein may further include operations, features, means, or instructions for determining a set of bits in a DCI field of the DCI message, where the indication of the active resource bandwidth for the second BWP corresponds to the set of bits in the DCI field, where determining the active resource bandwidth for the second BWP may be based on the set of bits in the DCI field of the DCI message.

Some examples of the method, apparatuses, and non-transitory computer-readable medium described herein may further include operations, features, means, or instructions for determining a BWP identifier associated with the second BWP based on a first subset of bits of the set of bits, where switching to the second BWP may be based on the BWP identifier. Some examples of the method, apparatuses, and non-transitory computer-readable medium described herein may further include operations, features, means, or instructions for determining a resource bandwidth identifier associated with the active resource bandwidth based on a second subset of bits of the set of bits, where communicating with the base station using the active resource bandwidth for the second BWP may be based on the BWP identifier and the resource bandwidth identifier.

Some examples of the method, apparatuses, and non-transitory computer-readable medium described herein may further include operations, features, means, or instructions for mapping the set of bits to an element in a data structure including a set of BWP identifiers and a set of resource bandwidth identifiers, and determining a BWP identifier associated with the second BWP and a resource bandwidth identifier associated with the active resource bandwidth for the second BWP based on the mapping.

Some examples of the method, apparatuses, and non-transitory computer-readable medium described herein may further include operations, features, means, or instructions for receiving an RRC configuration message including the data structure, where mapping the set of bits to the element in the data structure may be based on the RRC configuration message, where the data structure includes a table and the element includes an entry in the table, the entry identifying a BWP identifier or a resource bandwidth identifier, or both.

In some examples of the method, apparatuses, and non-transitory computer-readable medium described herein, selecting a subset of resource bandwidths of a second set of resource bandwidths associated with the second BWP based on the switching, where communicating with the base station includes: communicating with the base station using at last one resource bandwidth of the subset of resource bandwidths, where the subset of resource bandwidths may be initial resource bandwidths for the second BWP.

Some examples of the method, apparatuses, and non-transitory computer-readable medium described herein may further include operations, features, means, or instructions for receiving a DCI message including a DCI field, and determining one or more bits in the DCI field, where selecting the subset of resource bandwidths of the second set of resource bandwidths may be based on the one or more bits in the DCI field.

In some examples of the method, apparatuses, and non-transitory computer-readable medium described herein, determining a second active resource bandwidth for the second BWP based on a resource bandwidth switching pattern, where communicating with the base station includes: communicating with the base station using the second active resource bandwidth for the second BWP.

Some examples of the method, apparatuses, and non-transitory computer-readable medium described herein may further include operations, features, means, or instructions for receiving an RRC configuration message including an indication of the resource bandwidth switching pattern, where the resource bandwidth switching pattern may be based on a BWP or a BWP switching order, or both.

In some examples of the method, apparatuses, and non-transitory computer-readable medium described herein, the second active resource bandwidth for the second BWP may be based on the first BWP a first active resource band associated with the first BWP, the second BWP, a second set of resource bandwidths of the second BWP, or any combination thereof.

A method of wireless communication at a base station is described. The method may include determining a BWP configuration including a set of resource bandwidths of a first BWP, where at least one resource bandwidth of the set of resource bandwidths is a master resource bandwidth for a UE to use to communicate with the base station and transmitting a message including the BWP configuration to the UE.

An apparatus for wireless communication at a base station is described. The apparatus may include a processor, memory coupled with the processor, and instructions stored in the memory. The instructions may be executable by the processor to cause the apparatus to determine a BWP configuration including a set of resource bandwidths of a first BWP, where at least one resource bandwidth of the set of resource bandwidths is a master resource bandwidth for a UE to use to communicate with the base station and transmit a message including the BWP configuration to the UE.

Another apparatus for wireless communication at a base station is described. The apparatus may include means for determining a BWP configuration including a set of resource bandwidths of a first BWP, where at least one resource bandwidth of the set of resource bandwidths is a master resource bandwidth for a UE to use to communicate with the base station and transmitting a message including the BWP configuration to the UE.

A non-transitory computer-readable medium storing code for wireless communication at a base station is described. The code may include instructions executable by a processor to determine a BWP configuration including a set of resource bandwidths of a first BWP, where at least one resource bandwidth of the set of resource bandwidths is a master resource bandwidth for a UE to use to communicate with the base station and transmit a message including the BWP configuration to the UE.

Some examples of the method, apparatuses, and non-transitory computer-readable medium described herein may further include operations, features, means, or instructions for transmitting an indication of the master resource bandwidth to the UE.

Some examples of the method, apparatuses, and non-transitory computer-readable medium described herein may further include operations, features, means, or instructions for transmitting one or more of an RRC message, a DCI message, or a MAC-CE message including the indication of the master resource bandwidth to the UE, where the master resource bandwidth overlaps with an uplink band, a guard band, or a downlink band, or any combination thereof.

Some examples of the method, apparatuses, and non-transitory computer-readable medium described herein may further include operations, features, means, or instructions for transmitting a DCI message to the UE including a command for the UE to switch to a second BWP, where the DCI includes a set of bits in a DCI field of the DCI message identifying an active resource bandwidth for the second BWP.

In some examples of the method, apparatuses, and non-transitory computer-readable medium described herein, a BWP identifier associated with the second BWP corresponds to a subset of bits of the set of bits, or a resource bandwidth identifier associated with the active resource bandwidth corresponds to the subset of bits of the set of bits.

Some examples of the method, apparatuses, and non-transitory computer-readable medium described herein may further include operations, features, means, or instructions for transmitting an RRC configuration message including a data structure including a set of BWP identifiers and a set of resource bandwidth identifiers, where the set of bits map to an element in the data structure, the element identifying a BWP identifier or a resource bandwidth identifier, or both, where the data structure comprises a table.

Some examples of the method, apparatuses, and non-transitory computer-readable medium described herein may further include operations, features, means, or instructions for transmitting an RRC configuration message including an indication of a resource bandwidth switching pattern, where the resource bandwidth switching pattern may be based on a BWP or a BWP switching order, or both.

In some examples of the method, apparatuses, and non-transitory computer-readable medium described herein, the resource bandwidth switching pattern may be based on a BWP or a BWP switching order, or both.

### BRIEF DESCRIPTION OF THE DRAWINGS

FIGS. 1 and 2 illustrate examples of wireless communications systems that support duplex communications over bandwidth parts (BWPs) in accordance with aspects of the present disclosure.

FIGS. 3A through 3C illustrate examples of wireless communications systems that support that support duplex communications over BWPs in accordance with aspects of the present disclosure.

FIGS. 4A and 4B illustrate examples of configurations that support duplex communications over BWPs in accordance with aspects of the present disclosure.

FIG. 5 illustrates an example of a radio frequency spectrum subband configuration that supports duplex communications over BWPs in accordance with aspects of the present disclosure.

FIG. 6 illustrate an example of a BWP configuration that supports duplex communications over BWPs in accordance with aspects of the present disclosure.

FIGS. 7 and 8 show block diagrams of devices that support duplex communications over BWPs in accordance with aspects of the present disclosure.

FIG. 9 shows a block diagram of a user equipment (UE) communications manager that supports duplex communications over BWPs in accordance with aspects of the present disclosure.

FIG. 10 shows a diagram of a system including a device that supports duplex communications over BWPs in accordance with aspects of the present disclosure.

FIGS. 11 and 12 show block diagrams of devices that support duplex communications over BWPs in accordance with aspects of the present disclosure.

FIG. 13 shows a block diagram of a base station communications manager that supports duplex communications over BWPs in accordance with aspects of the present disclosure.

FIG. 14 shows a diagram of a system including a device that supports duplex communications over BWPs in accordance with aspects of the present disclosure.

FIGS. 15 through 19 show flowcharts illustrating methods that support duplex communications over BWPs in accordance with aspects of the present disclosure.

### DETAILED DESCRIPTION

Some wireless communication systems may include communication devices, such as user equipments (UEs) and base stations, for example, eNodeBs (eNBs), next-generation NodeBs or giga-NodeBs (either of which may be referred to as a gNB) that may support multiple radio access technologies. Examples of radio access technologies include fourth generation (4G) systems such as Long Term Evolution (LTE) systems and fifth generation (5G) systems which may be referred to as New Radio (NR) systems. The UEs and the base stations may support duplex communications, such as half-duplex communications and full-duplex communications, in 4G and 5G systems. The UEs and the base stations may also support various bandwidth parts (BWPs) for the half-duplex communications and the full-duplex communications.

The UEs and the base stations may experience interference issues due to the half-duplex communications and the full-duplex communications, which may affect a reliability of uplink communications and downlink communications between the UEs and the base stations. The UEs and the base stations may, in some cases, also experience latency with the duplex communications as a result of switching BWPs. As demand for communication efficiency increases, it may be desirable for the UEs and the base stations to provide improvements to BWP operations to support high reliability and low latency duplex communications, among other examples.

A UE may be configured to receive a BWP configuration defining a set of resource bandwidths (also referred to as sub-BWPs) for one or multiple BWPs. Each resource bandwidth may define time and frequency resources for one or multiple BWPs allocated for downlink communications or uplink communications. The UE may determine that at least one resource bandwidth in the set is a master resource bandwidth to be used for the downlink communications, or the uplink communications, or both. In some examples, the master resource bandwidth may be a default resource bandwidth for the UE, for example, if the UE does not determine or has not received any indication about which resource bandwidth to use for a given BWP. In other words, the master resource bandwidth may become an active resource bandwidth for a BWP unless the UE is signaled a particular resource bandwidth to use for the BWP (e.g., signaled by a base station). Therefore, the UE may communicate with a base station using a master resource bandwidth or a particular resource bandwidth signaled to the UE.

Aspects of the subject matter described in this disclosure may be implemented to realize one or more of the following potential improvements, among others. The techniques employed by UEs may provide benefits and enhancements to the operation of the UEs. For example, operations performed by the UEs may provide improvements to BWP operations. In some examples, configuring the UEs to support a master resource bandwidth for a BWP may support provide flexibility for duplex communications at the UEs. In some other examples, configuring the UEs to support a master resource bandwidth for a BWP may provide improvements to power consumption, spectral efficiency, and, in some examples, may promote high reliability and low latency duplex communications, among other benefits.

Aspects of the disclosure are initially described in the context of wireless communications systems. Aspects of the disclosure are further illustrated by and described with reference to apparatus diagrams, system diagrams, and flowcharts that relate to duplex communications over BWPs.

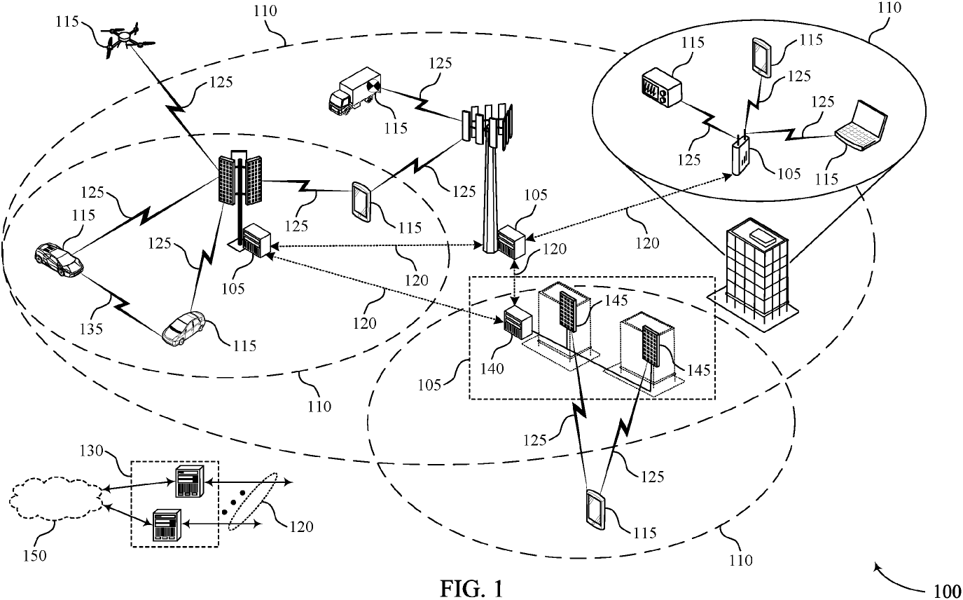

FIG. 1 illustrates an example of a wireless communications system 100 that supports duplex communications over BWPs in accordance with aspects of the present disclosure. The wireless communications system 100 may include one or more base stations 105, one or more UEs 115, and a core network 130. In some examples, the wireless communications system 100 may be an LTE network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links. One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples. The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a BWP) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode). A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δƒ) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The wireless communications system 100 may support duplex communications, such as half-duplex communications and full-duplex communications. The wireless communications system 100 may support the duplex communication over various BWPs. The base stations 105 and the UEs 115 may experience interference issues due to the duplex communications, which may impact a reliability and a latency of the wireless communications system 100. The base stations 105 and the UEs 115 may experience a delay in the duplex communications due to a BWP switching by the base stations 105 and the UEs 115. As demand for communication efficiency increases, it may be desirable for the wireless communications system 100 to provide improvements to BWP operations to support high reliability and low latency duplex communications, among other examples.

A UE 115 may receive a BWP configuration defining a set of resource bandwidths (also referred to as sub-BWPs) for the one or multiple BWPs. Each resource bandwidth may define time and frequency resources associated with the one or multiple BWPs allocated for downlink communications or uplink communications. The resource bandwidths may thus accommodate disjoint bandwidth allocation for duplex communications, such as full-duplex communications supporting both downlink communications and uplink communications. The UE 115 may determine that at least one resource bandwidth in the set is a master resource bandwidth (also referred to as a default resource bandwidth) used for the downlink communications or the uplink communications, or both.

For example, the master resource bandwidth may function as a default resource bandwidth for the UE 115, if the UE 115 does not know (e.g., a base station 105 does not explicitly signal the UE 115 to use a particular resource bandwidth) which resource bandwidth to use for a BWP. The master resource bandwidth may also provide flexibility for the UE 115 when switching BWPs in which the master resource bandwidth becomes an active resource bandwidth unless the UE 115 is explicitly signaled a particular resource bandwidth. The described techniques may, as a result, include features for improvements to BWP operations when switching BWPs and, in some examples, may promote high reliability and low latency duplex communications over different BWPs in the wireless communications system 100, among other benefits.

The time intervals for the base stations 105 or the UEs 115 may be expressed in multiples of a basic time unit which may, for example, refer to a sampling period of Tₛ = ⅟(Δƒₘₐₓ ▪ N_{ƒ}) seconds, where Δƒₘₐₓ may represent the maximum supported subcarrier spacing, and N_{ƒ} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{ƒ}) sampling periods. The duration of a symbol period may depend on the subcarrier spacing or frequency band of operation. A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers. In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

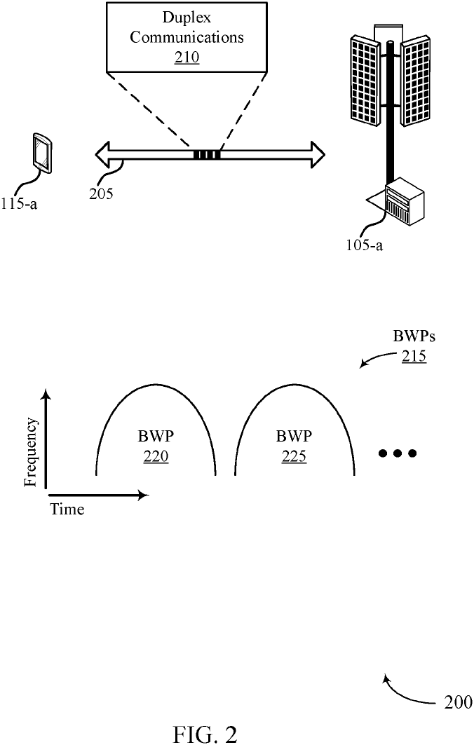

FIG. 2 illustrates an example of a wireless communications system 200 that supports duplex communications over BWPs in accordance with aspects of the present disclosure. The wireless communications system 200 may implement aspects of the wireless communications system 100. For example, the wireless communications system 200 may include a base station 105-a and a UE 115-a, which may be examples of a base station 105 and a UE 115 as described herein. The wireless communications system 200 may support multiple radio access technologies including 4G systems such as LTE systems, LTE-A systems, or LTE-A Pro systems, and 5G systems, which may be referred to as NR systems.

The base station 105-a and the UE 115-a may be configured with multiple antennas, which may be used to employ techniques such as transmit diversity, receive diversity, MIMO communications, or beamforming, or any combination thereof. The antennas of the base station 105-a and the UE 115-a may be located within one or more antenna arrays or antenna panels, which may support MIMO operations or transmit or receive beamforming. For example, the base station 105-a antennas or antenna arrays may be co-located at an antenna assembly, such as an antenna tower. In some examples, antennas or antenna arrays associated with the base station 105-a may be located in diverse geographic locations. The base station 105-a may have an antenna array with a number of rows and columns of antenna ports that the base station 105-a may use to support beamforming of communications with the UE 115-a. Likewise, the UE 115-a may have one or more antenna arrays that may support various MIMO or beamforming operations. Additionally or alternatively, an antenna panel may support radio frequency beamforming for a signal transmitted via one or more antenna ports. The base station 105-a and the UE 115-a may thus be configured to support directional communications 205 (e.g., beamformed communications) using the multiple antennas.

The base station 105-a and the UE 115-a may communicate via the directional communications 205 using multiple component carriers. For example, the base station 105-a and the UE 115-a may be configured to support multiple downlink component carriers and multiple uplink component carriers. The base station 105-a and the UE 115-b may be configured to support the directional communications 205 over a carrier bandwidth or may be configured to support the directional communications 205 over one of multiple carrier bandwidths. In some examples, the base station 105-a or the UE 115-a may support duplex communications 210, such as half-duplex communications, or full-duplex communications, or both, via carriers associated with multiple carrier bandwidths over the directional communications 205.

The base station 105-a and the UE 115-a may, in some cases, support subband half-duplex communications or subband full-duplex communications. The base station 105-a and the UE 115-a may support duplex communications using TDD techniques or FDD techniques. The base station 105-a and the UE 115-a may, in some cases, support TDD operations and FDD operations in an unpaired spectrum or a paired spectrum. An unpaired spectrum provides a single subband or a single band for both downlink communications and uplink communications. A paired spectrum provides a distinct subband or band for downlink communications and uplink communications. For example, the wireless communications system 200 may have a block of radio frequency spectrum in a lower frequency band and an associated block of radio frequency spectrum in an upper frequency band.

An arrangement of frequency bands with one band for the uplink communications and one band for the downlink communications may be referred to as paired spectrum. The UE 115-a may be configured for operating over portions of a radio frequency spectrum band (e.g., a bandwidth). For example, the UE 115-a may be configured to operate over one or multiple BWPs 215. In some cases, when the base station 105-a and the UE 115-a are configured with multiple antenna panels, where one antenna panel may be dedicated for downlink communications and another antenna panel may be dedicated for uplink communications in an unpaired spectrum or a paired spectrum, the base station 105-a and the UE 115-a may experience self-interference when communicating over the one or multiple BWPs 215. The self-interference may be a result of simultaneously using multiple antenna panels for uplink communications and downlink communications (e.g., in full-duplex communications) over the one or multiple BWPs 215.

The UE 115-a may be configured to receive a BWP configuration defining a set of resource bandwidths for one or multiple BWPs, such as BWPs 215. Each resource bandwidth may define time and frequency resources for one or multiple BWPs 215 allocated for duplex communications 210. The UE 115-a may determine that at least one resource bandwidth in the set is a master resource bandwidth to be used for the duplex communications 210 (e.g., downlink communications, or the uplink communications, or both). In some examples, the master resource bandwidth may be a default resource bandwidth for the UE 115-a, for example, if the UE 115-a does not determine or has not received any indication about which resource bandwidth to use for one or more given BWPs 215. In other words, the master resource bandwidth may become an active resource bandwidth for one or more BWPs 215 unless the UE 115-a is signaled a particular resource bandwidth to use for the one or more BWPs 215 (e.g., signaled by a base station 105-a). Therefore, the UE 115-a may communicate with a base station 105-a using a master resource bandwidth or a particular resource bandwidth signaled to the UE 115-a.

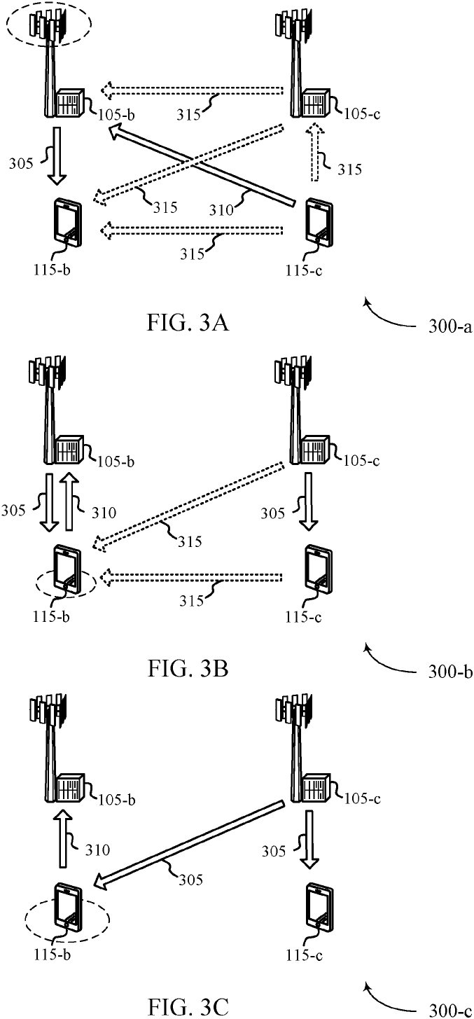

FIG. 3A illustrates an example of a wireless communications system 300 that supports duplex communications over BWPs in accordance with aspects of the present disclosure. The wireless communications system 300-a may, in some examples, implement aspects of the wireless communications systems 100 and 200. For example, the wireless communications system 300-a may support duplex communications over BWPs. In the example of FIG. 3A, the base station 105-b and the base station 105-c may be configured to support full-duplex communications in the wireless communications system 300-a. For example, the base station 105-b and the base station 105-c may support full-duplex communications with the UE 115-b and the UE 115-c. The base station 105-b, the base station 105-c, the UE 115-b, and the UE 115-c may be examples of base stations 105 and UEs 115 described herein.

The UE 115-b and the UE 115-c may be configured to operate in a half-duplex mode or a full-duplex mode. In the half-duplex mode, the UE 115-b and the UE 115-c may be configured to either receive downlink communications from the base station 105-b and the base station 105-c, or transmit uplink communications to the base station 105-b and the base station 105-c. In other words, in the half-duplex mode, the UE 115-b and the UE 115-c may be unable to jointly receive downlink communications and transmit uplink communications during a same time period. In the full-duplex mode, however, the UE 115-b and the UE 115-c may be configured to simultaneously receive downlink communications and transmit uplink communications from and to the base station 105-b and the base station 105-c during a same time period. The base station 105-b and the base station 105-c may provide downlink communications using one or multiple directional beams. Likewise, the UE 115-b and the UE 115-c may provide uplink communications using one or multiple directional beams.

With reference to FIG. 3A, the base station 105-b and the base station 105-c may operate in a full-duplex mode, while the UE 115-b and the UE 115-c operate in a half-duplex mode. In some cases, one or more of the base station 105-b, the base station 105-c, the UE 115-b, and the UE 115-c may experience interference in the wireless communications system 300-a. For example, the base station 105-b may experience self-interference from downlink communications to uplink communications. By way of example, the base station 105-b may transmit downlink communications 305 to the UE 115-b using at least one antenna panel of the base station 105-b, as well as receive uplink communications 310 from the UE 115-c using another antenna panel of the base station 105-b. This may cause self-interference at the base station 105-b due to, for example, simultaneous transmission of the downlink communications 305 using the at least one antenna panel of the base station 105-b and reception of the uplink communications 310 from the UE 115-c using another antenna panel of the base station 105-b.

The base station 105-b may experience some interference communications 315 from the base station 105-c that may relate to downlink communications from the base station 105-c to the UE 115-b, or downlink communications from the base station 105-c to the UE 115-c. Similarly, the UE 115-b may experience some interference communications 315 from the UE 115-c that may relate to uplink communications from the UE 115-c to the base station 105-c. Additionally or alternatively, the base station 105-c may experience some interference communications 315 from the UE 115-c that may relate to the uplink communications 310 from the UE 115-c to the base station 105-b. To mitigate the self-interference at the UEs 115, the UE 115-b and the UE 115-c (or any other UE 115) may determine a master resource bandwidth for a BWP allocated for uplink communications or downlink communications, or both.

For example, the UE 115-b and the UE 115-c may be configured to receive a BWP configuration defining a set of resource bandwidths for one or multiple BWPs. Each resource bandwidth may define time and frequency resources for one or multiple BWPs allocated for duplex communications. The UE 115-b and the UE 115-c may determine that at least one resource bandwidth in the set is a master resource bandwidth to be used for the duplex communications (e.g., downlink communications, or the uplink communications, or both). In some examples, the master resource bandwidth may be a default resource bandwidth for the UE 115-b and the UE 115-c, for example, if the UE 115-b and the UE 115-c do not determine or has not received any indication about which resource bandwidth to use for one or more given BWPs. As such, the base station 105-b and the base station 105-c may schedule, and the UE 115-b and the UE 115-c may perform, duplex communications that take into account BWPs and resource bandwidths for the BWPs as described herein.

FIG. 3B illustrates an example of a wireless communications system 300-b in accordance with aspects of the present disclosure. The wireless communications system 300-b may, in some examples, implement aspects of the wireless communications systems 100 and 200. For example, the wireless communications system 300-b may support half-duplex communications or full-duplex communications. In the example of FIG. 3B, the base station 105-b and the base station 105-c may be configured to support full-duplex communications in the wireless communications system 300-b. For example, the base station 105-b and the base station 105-c may support full-duplex communications with the UE 115-b and the UE 115-c. The base station 105-b, the base station 105-c, the UE 115-b, and the UE 115-c may be examples of base stations 105 and UEs 115 described herein.

In the example of FIG. 3B, the UE 115-b and the UE 115-c may be configured to operate in a full-duplex mode. In the full-duplex mode, the UE 115-b and the UE 115-c may be configured to concurrently receive downlink communications and transmit uplink communications from and to the base station 105-b and the base station 105-c. Likewise, the base station 105-b and the base station 105-c may also operate in a full-duplex mode. The base station 105-b and the base station 105-c may provide downlink communications using one or multiple directional beams. Similarly, the UE 115-b and the UE 115-c may provide uplink communications using one or multiple directional beams. In some cases, one or more of the base station 105-b, the base station 105-c, the UE 115-b, and the UE 115-c may experience self-interference or other interference in the wireless communications system 300-b. For example, the UE 115-b may experience self-interference from downlink communications to uplink communications.

By way of example, the base station 105-b may transmit downlink communications 305 to the UE 115-b, which the UE 115-b may receive via at least one antenna panel of the UE 115-b. The UE 115-b may also transmit uplink communications 310 to the base station 105-b via another antenna panel of the UE 115-b. This may cause self-interference at the UE 115-b due to, for example, simultaneous reception of the downlink communications 305 using the at least one antenna panel of the UE 115-b and transmission of the uplink communications 310 using the other antenna panel of the UE 115-b. Likewise, the base station 105-c may transmit downlink communications 305 to the UE 115-c, and the UE 115-c may transmit uplink communications (not shown) to the base station 105-c. This may cause self-interference at the UE 115-c. The base station 105-b or the UE 115-b, or both, may also experience some interference communications 315 from the base station 105-c or the UE 115-c, or both. The interference communications 315 may be associated with the downlink communications 305 from the base station 105-c to the UE 115-c, or the uplink communications (not shown) from the UE 115-c to the base station 105-c, or both. To reduce or eliminate the self-interference at the UEs 115, the UE 115-b and the UE 115-c (or any other UE 115) may determine a master resource bandwidth for a BWP allocated for uplink communications or downlink communications, or both.

For example, the UE 115-b and the UE 115-c may be configured to receive a BWP configuration defining a set of resource bandwidths for one or multiple BWPs. The UE 115-b and the UE 115-c may determine that at least one resource bandwidth in the set is a master resource bandwidth to be used for the duplex communications (e.g., downlink communications, or the uplink communications, or both). In some examples, the master resource bandwidth may be a default resource bandwidth for the UE 115-b and the UE 115-c, for example, if the UE 115-b and the UE 115-c do not determine or has not received any indication about which resource bandwidth to use for one or more given BWPs. The base station 105-b and the base station 105-c may schedule, and the UE 115-b and the UE 115-c may perform duplex communications that take into account BWPs and resource bandwidths for the BWPs as described herein.

FIG. 3C illustrates an example of a wireless communications system 300-c in accordance with aspects of the present disclosure. The wireless communications system 300-c may, in some examples, implement aspects of the wireless communications systems 100 and 200. For example, the wireless communications system 300-c may support half-duplex communications or full-duplex communications. In the example of FIG. 3C, base station 105-b and the base station 105-c may be configured to support full-duplex communications in the wireless communications system 300-b. For example, the base station 105-b and the base station 105-c may support full-duplex communications with UE 115-b and the UE 115-c. The base station 105-b, the base station 105-c, the UE 115-b, and the UE 115-c may be examples of base stations 105 and UEs 115 described herein.

In the example of FIG. 3C, the UE 115-b and the UE 115-c may be configured to operate in a full-duplex mode with multiple-transmission and reception points (multi-TRPs). In the full-duplex mode, the UE 115-b and the UE 115-c may be configured to concurrently receive downlink communications and transmit uplink communications from and to the base station 105-b and the base station 105-c. Likewise, the base station 105-b and the base station 105-c may also operate in a full-duplex mode. The base station 105-b and the base station 105-c may provide downlink communications using one or multiple directional beams. Similarly, the UE 115-b and the UE 115-c may provide uplink communications using one or multiple directional beams. In some cases, one or more of the base station 105-b, the base station 105-c, the UE 115-b, and the UE 115-c may experience self-interference or other interference in the wireless communications system 300-b. For example, the UE 115-b may experience self-interference from downlink communications to uplink communications.

By way of example, the UE 115-b may receive downlink communications 305 from the base station 105-c using one TRP of the UE 115-b, and transmit uplink communications 310 to the base station 105-b using another TRP of the UE 115. The reception of the downlink communications 305 and the transmission of the uplink communications 310 may occur simultaneously. This may cause self-interference at the UE 115-b. Similarly, the base station 105-c may transmit downlink communications 305 to the UE 115-b using one TRP of the base station 105-c and transmit downlink communications 305 to the UE 115-c using another TRP of the base station 105-c. To reduce or eliminate the self-interference at the UEs 115, the UE 115-b and the UE 115-c (or any other UE 115) may determine a master resource bandwidth for a BWP allocated for uplink communications or downlink communications, or both.

The UE 115-b and the UE 115-c may be configured to receive a BWP configuration defining a set of resource bandwidths for one or multiple BWPs. The UE 115-b and the UE 115-c may determine that at least one resource bandwidth in the set is a master resource bandwidth to be used for the duplex communications (e.g., downlink communications, or the uplink communications, or both). In some examples, the master resource bandwidth may be a default resource bandwidth for the UE 115-b and the UE 115-c, for example, if the UE 115-b and the UE 115-c do not determine or has not received any indication about which resource bandwidth to use for one or more given BWPs. The base station 105-b and the base station 105-c may schedule, and the UE 115-b and the UE 115-c may perform duplex communications that take into account BWPs and resource bandwidths for the BWPs as described herein.

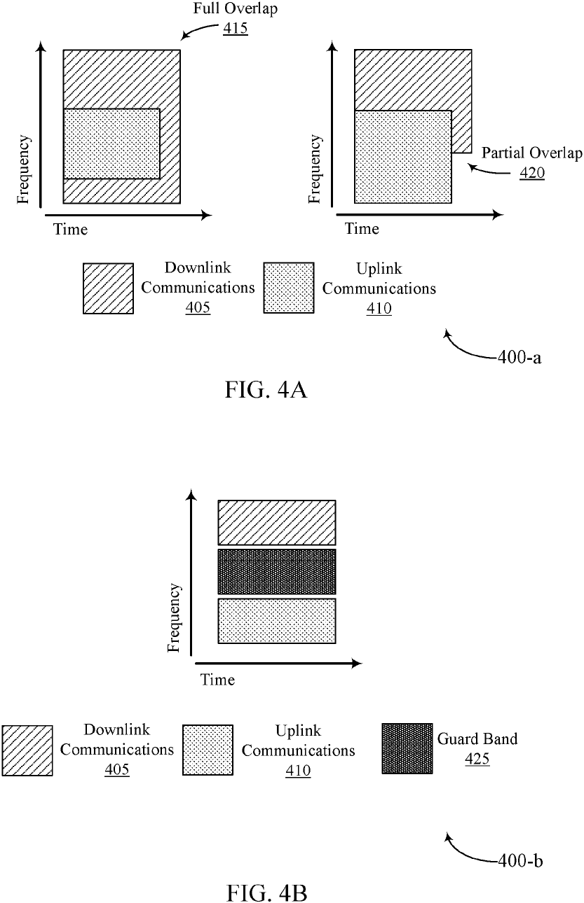

FIG. 4A illustrates an example of a configuration 400-a that supports duplex communications over BWPs in accordance with aspects of the present disclosure. The configuration 400-a may implement aspects of the wireless communications systems 100 and 200. For example, the configuration 400-a may be based on a full-duplex configuration provided by a base station 105 and implemented by the base station 105 or a UE 115, or both. In some examples, the base station 105 or the UE 115, or both, may support in-band full-duplex (IBFD) operations. According to IBFD operations, the base station 105 and the UE 115 may transmit and receive communications simultaneously in a same frequency band, and thereby increase throughput of a wireless communication systems, for example the wireless communications systems 100 and 200.

The base station 105 and the UE 115 may, for example, transmit and receive communications (e.g., downlink communications 405, uplink communications 410) on same time and frequency resources, such as symbol, a minislot, a subframe, frames, subcarriers, carriers, etc. The downlink communications 405 and the uplink communications 410 may thereby share same IBFD time and frequency resources. The base station 105 may provide downlink communications 405 using one or multiple directional beams via one or more antenna panels. Similarly, the UE 115 may provide uplink communications 410 using one or multiple directional beams via one or more antenna panels. In some examples, there may be a full overlap 415 between IBFD time and frequency resources associated with the downlink communications 405 and the uplink communications 410. In some other examples, there may be a partial overlap 420 between IBFD time and frequency resources associated with the downlink communications 405 and the uplink communications 410. In accordance with aspects of the present disclosure, a UE 115 operating in a full-duplex mode, such as configurations illustrated by the configuration 400-a, may determine a master resource bandwidth for a BWP allocated for uplink communications or downlink communications, or both.

For example, a UE 115 may be configured to receive a BWP configuration defining a set of resource bandwidths for one or multiple BWPs. The UE 115 may determine that at least one resource bandwidth in the set is a master resource bandwidth to be used for the duplex communications (e.g., downlink communications, or the uplink communications, or both). In some examples, the master resource bandwidth may be a default resource bandwidth for the UE 115, for example, if the UE 115 does not determine or has not received any indication about which resource bandwidth to use for one or more given BWPs. The base station 105 may schedule, and the UE 115 may perform duplex communications that take into account BWPs and resource bandwidths for the BWPs as described herein. A base station 105 may thereby schedule, and the UE 115 may perform, duplex communications that take into account BWPs and resource bandwidths for the BWPs as described herein.

FIG. 4B illustrates an example of a configuration 400-b that supports duplex communications over BWPs in accordance with aspects of the present disclosure. The configuration 400-b may implement aspects of the wireless communications systems 100 and 200. For example, the configuration 400-b may be based on a full-duplex configuration provided by a base station 105, and implemented by the base station 105 or a UE 115, or both. The base station 105 may support full-duplex communications including transmitting downlink communications 405, and receiving uplink communications 410, using one or multiple directional beams. Similarly, the UE 115 may support full-duplex communications including transmitting uplink communications 410 in an uplink band, and receiving the downlink communications 405 in a downlink band, using one or multiple directional beams via one or more antenna panels. In some examples, the base station 105 or the UE 115, or both, may support FDD operations resources associated with full-duplex communications.

The base station 105 and the UE 115 may, for example, transmit and receive communications (e.g., the downlink communications 405, the uplink communications 410) on same time resources (e.g., symbol, a minislot, a subframe, frames) but different frequency resources (e.g., subcarriers, carriers). As such, the downlink communications 405 and the uplink communications 410 may be separated in a frequency domain. Additionally or alternatively, in some examples, there may be a guard band 425 in a frequency domain between the downlink communications 405 in a downlink band and the uplink communications 410 in an uplink band. The guard band 425 may be an unused part of a radio frequency spectrum between at least two radio frequency spectrum subbands or bands, for preventing interference, for example, between the downlink communications 405 in the downlink band and the uplink communications 410 in the uplink band. In accordance with aspects of the present disclosure, a UE 115 operating in a full-duplex mode, such as configurations illustrated by the configuration 400-b, may determine a master resource bandwidth for a BWP allocated for uplink communications or downlink communications, or both.

For example, a UE 115 may be configured to receive a BWP configuration defining a set of resource bandwidths for one or multiple BWPs. The UE 115 may determine that at least one resource bandwidth in the set is a master resource bandwidth to be used for the duplex communications (e.g., downlink communications, or the uplink communications, or both). In some examples, the master resource bandwidth may be a default resource bandwidth for the UE 115, for example, if the UE 115 does not determine or has not received any indication about which resource bandwidth to use for one or more given BWPs. The base station 105 may schedule, and the UE 115 may perform duplex communications that take into account BWPs and resource bandwidths for the BWPs as described herein. A base station 105 may thereby schedule, and the UE 115 may perform, duplex communications that take into account BWPs and resource bandwidths for the BWPs as described herein.

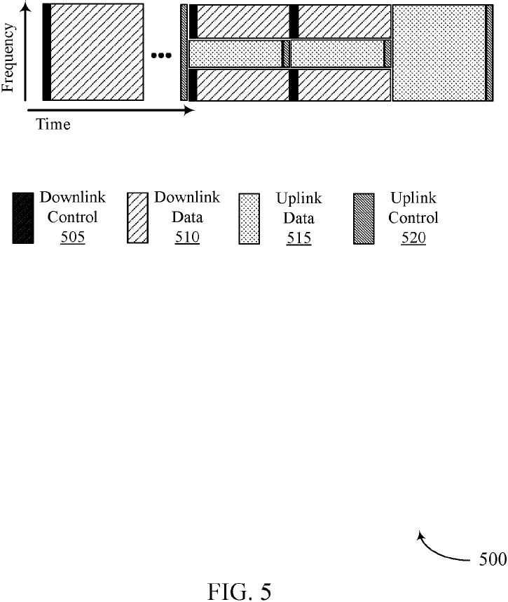

FIG. 5 illustrates an example of a radio frequency spectrum subband configuration 500 that supports duplex communications over BWPs in accordance with aspects of the present disclosure. The radio frequency spectrum subband configuration 500 may implement aspects of the wireless communications systems 100 and 200. For example, a base station 105 or a UE 115, or both, as described herein may support various types of frequency ranges, such as Sub 6 GHz range (also referred to as FR1) and millimeter wave (mmW) range (also referred to as FR2). In some examples, the base station 105 or the UE 115, or both, may support a multiplexing operation on time and frequency resources when operating in one or multiple radio frequency spectrum subbands. The multiplexing operation may be an FDD operation and a TDD operation. The radio frequency spectrum subband configuration 500 may reduce or mitigate self-interference by isolating antenna panels of the base station 105 or the UE 115, or both. This isolation may provide an improvement to reduction of noise experienced at antenna panels (e.g., SNR > 50db or SNR > 40 dB for sub-band full duplex).

In the example of FIG. 5, the base station 105 or the UE 115, or both, may support an FDD operation and a TDD operation on time and frequency resources for downlink communications (e.g., downlink control 505, downlink data 510) and uplink communications (e.g., uplink control 515, uplink data 520) in an unpaired spectrum. One or more downlink bands and one or more uplink bands may be in different portions of a radio frequency spectrum. In some examples, there may be a guard band between a downlink band and an uplink band. The base station 105 may provide downlink communications (e.g., downlink control 505, downlink data 510) using one or multiple directional beams via one or multiple antenna panels according to the radio frequency spectrum subband configuration 500 (e.g., TDD and FDD). The UE 115 may also provide uplink communications (e.g., uplink control 515, uplink data 520) using one or multiple directional beams via one or multiple antenna panels according to the radio frequency spectrum subband configuration 500 (e.g., TDD and FDD). The base station 105 or the UE 115, or both, may thus support FDD and TDD operations in an unpaired spectrum for duplexed communications between the base station 105 and the UE 115.

The radio frequency spectrum subband configuration 500 may mitigate self-interference at a base station 105 or a UE 115, or both. For example, the base station 105 or the UE 115, or both, may be configured with at least two separate antenna panels for simultaneous transmission and reception operations. For example, the base station 105 may be configured with at least two separate antenna panels for simultaneous transmission and reception operations. Likewise, the UE 115 may be configured with at least two separate antenna panels for simultaneous transmission and reception operations. With reference to FIG. 5, in some examples, one antenna panel of the two may be configured for downlink transmission at both edges of the radio frequency spectrum subband configuration 500, while the other antenna panel of the two may be configured for uplink reception in the middle of the radio frequency spectrum subband configuration 500.

The base station 105 or the UE 115, or both, may support a time domain windowed overlap-and-add (WOLA) to reduce an adjacent-channel-leakage-ratio (ACLR) for a downlink signal or an uplink signal. The base station 105 or the UE 115, or both, may use an analog low-pass filter to improve an analog-to-digital converter (ADC) dynamic range. The base station 105 or the UE 115, or both, may improve automatic gain control (AGC) states to improve a noise figure (NF). In some examples, a digital integrated circuit of the ACLR leakage may be above 20 dB (i.e., ACLR leakage > 20db). The base station 105 or the UE 115, or both, may use a non-linear model per each transmitter-receiver pair. In accordance with aspects of the present disclosure, a UE 115 operating in a full-duplex mode, such as configurations illustrated by the radio frequency spectrum subband configuration 500, may determine a master resource bandwidth for a BWP allocated for uplink communications or downlink communications, or both. As such, a base station 105 may schedule, and the UE 115 may perform, duplex communications that take into account BWPs and resource bandwidths for the BWPs as described herein.

Returning to FIG. 2, the UE 115-a may switch a BWP when communicating with the base station 105-a. For example, the UE 115-a may switch from a BWP 220 to a BWP 225 for communicating with the base station 105-a. In some examples, the UE 115-a may switch a BWP based on receiving a message from the base station 105-a. In some examples, the message may be a DCI message that may include a DCI command for the UE 115-a to switch a BWP and include a BWP identifier that may indicate for the UE 115-a the BWP to switch to. The message may identify a specific BWP that can be activated by a BWP identifier (e.g., which may be also referred to as a BWP indicator). In some other examples, the message may be an RRC message or a MAC-CE, among others.

A bandwidth within a BWP 215 (e.g., the BWP 220, the BWP 225, or both) may, in some cases, be impacted because of a downlink band, a guard band, or an uplink band, or any combination thereof. The base station 105-a may thus configure the UE 115-a with one or more resource bandwidths that correspond to time and frequency resources associated with the BWP 215 (e.g., the BWP 220, the BWP 225, or both) allocated for downlink communications or uplink communications. The resource bandwidths may thus accommodate disjoint bandwidth allocation for duplex communications, such as full-duplex communications supporting both downlink communications and uplink communications. As described herein, the base station 105-a and the UE 115-a may support j oint indication to switch BWP and resource bandwidths.

The UE 115-a may be configured to receive, from the base station 105-a, a BWP configuration defining a set of resource bandwidths for one or multiple BWPs 215. Each resource bandwidth may define time and frequency resources for one or multiple BWPs 215 allocated for downlink communications or uplink communications. The UE 115-a may determine that at least one resource bandwidth in the set is a master resource bandwidth used for the downlink communications or the uplink communications, or both. In some examples, the master resource bandwidth may be a default resource bandwidth for the UE 115-a, if the UE 115-a does not know which resource bandwidth to use for a BWP 215. In other words, the master resource bandwidth may become an active resource bandwidth for a BWP 215, unless the UE is explicitly signaled a particular resource bandwidth to use for the BWP 215. Therefore, the UE 115-a may communicate with the base station 105-a using a master resource bandwidth or a particular resource bandwidth signaled to the UE 115-a.

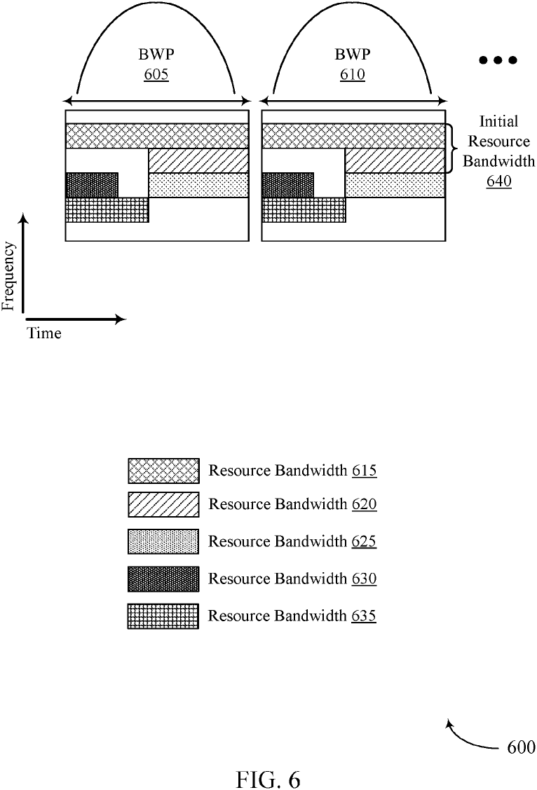

FIG. 6 illustrates an example of a BWP configuration 600 that supports duplex communications over BWPs in accordance with aspects of the present disclosure. The BWP configuration 600 may implement aspects of the wireless communications systems 100 and 200 described with reference to FIGS. 1 and 2, respectively. For example, the BWP configuration 600 may support half-duplex communications or full-duplex communications. The BWP configuration 600 may be based on a configuration by a base station 105 or a UE 115, and implemented by the UE 115 and may promote power saving for the UE 115 by supporting BWP operations. The BWP configuration 600 may also be based on a configuration by the base station 105 or the UE 115, and implemented by the UE 115 to promote high reliability and low latency wireless communications by providing an indication identifying one or more BWPs and one or more resource bandwidths, among other benefits.

A UE 115 may communicate (e.g., receive downlink communications or transmit uplink communications or both) with a base station 105, or another UE 115, or both, over one or more BWPs. For example, the UE 115 may communicate with the base station 105 over a BWP 605. The UE 115 may identify a set of resource bandwidths (e.g., time and frequency resources) of the BWP 605 or the BWP 610, or both, based on a BWP configuration. For example, the UE 115 may identify a resource bandwidth 615, identify a resource bandwidth 620, identify a resource bandwidth 625, identify a resource bandwidth 630, identify a resource bandwidth 635, or a combination thereof associated with the BWP 605 based on the BWP configuration. In some examples, the UE 115 may receive separate BWP configurations for the BWP 605 and the BWP 610.

The UE 115 may determine that at least one resource bandwidth of the set of resource bandwidths is a master resource bandwidth for each of the BWP 605 and the BWP 610. The master resource bandwidth may be defined for downlink communications or uplink communications, or both. In some examples, the UE 115 may receive an indication of the master resource bandwidth from the base station 105. The UE 115 may determine that the at least one resource bandwidth of the set of resource bandwidths is the master resource bandwidth based on the indication. In some examples, the UE 115 may receive an RRC message including the indication of the master resource bandwidth. In some other examples, the UE 115 may receive a DCI message including the indication of the master resource bandwidth. In other examples, the UE 115 may receive a MAC-CE message including the indication of the master resource bandwidth.

Alternatively, the UE 115 may determine that at least one resource bandwidth of the set of resource bandwidths is a master resource bandwidth based on a rule. The UE 115 may determine the at least one resource bandwidth of the set of resource bandwidths is the master resource bandwidth by determining that the at least one resource bandwidth meets one or more given criteria. In some examples for such criteria, the UE 115 may determine the at least one resource bandwidth of the set of resource bandwidths is the master resource bandwidth by determining that the at least one resource bandwidth corresponds to a smallest resource bandwidth of the set of resource bandwidths. For example, the UE 115 may determine that the resource bandwidth 630 is the master resource bandwidth because the resource bandwidth 630 may be the smallest resource bandwidth of the set of resource bandwidths.

In some examples for such criteria, the UE 115 may alternatively determine the at least one resource bandwidth of the set of resource bandwidths is the master resource bandwidth by determining that the at least one resource bandwidth corresponds to a largest resource bandwidth of the set of resource bandwidths. For example, the UE 115 may determine that the resource bandwidth 615 is the master resource bandwidth because the resource bandwidth 615 may be the largest resource bandwidth of the set of resource bandwidths.

In some examples for such criteria, the UE 115 may, additionally or alternatively, determine that at least one resource bandwidth of the set of resource bandwidths is a master resource bandwidth based on a least possible overlap with a downlink band, a guard band, or an uplink band, or any combination thereof.

The UE 115 may switch BWP, for example from the BWP 605 to the BWP 610. As part of BWP switching, a master resource bandwidth may become an active resource bandwidth unless the UE 115-a is explicitly signaled a specific resource bandwidth for the BWP 610. The UE 115 may determine that the master resource bandwidth associated with the BWP 605 is an active resource bandwidth for the BWP 610 based on a configuration, and the UE 115 may communicate with the base station 105 using the active resource bandwidth for the BWP 610. In some examples, the UE 115 may determine an active resource bandwidth for the BWP 610 based on receiving an indication of the active resource bandwidth for the BWP 610. The active resource bandwidth associated with the BWP 610 may be different from the master resource bandwidth associated with the BWP 605. Likewise, a masseter resource bandwidth associated with the BWP 610 may be different from a master resource bandwidth associated with the BWP 610. For example, the resource bandwidth 615 may be the master resource bandwidth for the BWP 605, while the resource bandwidth 620 may be the master resource bandwidth for the BWP 610.

In some examples, the UE 115 may receive a DCI message including an indication to perform the BWP switching. The UE 115 may use one or more bits in the DCI message to determine a new resource bandwidth within the BWP 610 (e.g., a new BWP). The number of bits may determine the new resource bandwidth, and the number of bits may depend on the number of resource bandwidths in the BWP 610 (e.g., the new BWP). For example, if the BWP 610 (e.g., the new BWP) is configured with two resource bandwidths, then one bit indication of the new resource bandwidth may be sufficient. In some examples, two bits can be used to identify a BWP identifier out of four BWP and N bits to determine 2^{N} resource bandwidths. The UE 115 may receive a DCI message from the base station 105, and determine a set of bits in a DCI field of the DCI message. The indication of the active resource bandwidth for the BWP 610 may correspond to the set of bits in the DCI field. The UE 115 may determine a BWP identifier associated with the BWP 610 based on a first subset of bits of the set of bits. The UE 115 may, in some examples, switch to the BWP 610 based on the BWP identifier. The UE 115 may also determine a resource bandwidth identifier associated with the active resource bandwidth based on a second subset of bits of the set of bits.

Alternatively, the UE 115 may be RRC configured with a data structure, which may be an 2^{M} table (e.g., Table 1 below) for joint indication of a BWP and a resource bandwidth identifier. The UE 115 may identify a value of M based on one or more bits in a DCI message, which may indicate an element in the data structure. The UE 115 may, for example, receive an RRC configuration message including the data structure, which may be a table and the element includes an entry (e.g., a row, a column, or both) in the table. The entry may identify a BWP identifier or a resource bandwidth identifier, or both. With reference to Table 1 below, M may be 3. Thus, the UE 115 may identify a BWP identify and a resource bandwidth identifier based on a codepoint including at least 3 bits.

TABLE 1

BWP and Resource Bandwidth Table

| Codepoint | BWP Identifier | Resource Bandwidth Identifier |
|---|---|---|
| 000 | 1 | 1 |
| 001 | 1 | 2 |
| 010 | 1 | 3 |
| 011 | 2 | 1 |
| ... | ... | ... |
| 111 | 2 | 4 |

The UE 115 may map the set of bits received in the DCI field to an element in a data structure (e.g., the Table 1) including a set of BWP identifiers and a set of resource bandwidth identifiers. The UE 115 may determine a BWP identifier associated with the BWP 610 and a resource bandwidth identifier associated with the active resource bandwidth for the BWP 610 based on the mapping.

Use of a subset of resource bandwidths including the resource bandwidth 615, the resource bandwidth 620, the resource bandwidth 625, the resource bandwidth 630, the resource bandwidth 635, or both may be allowed during the BWP switching. Thus, if the BWP is switched via a DCI message, the DCI message may include extra bits to select from those resource BWs that are allowed as an initial resource bandwidth. For example, a BWP can be configured with 10 resource bandwidth, but two of these resource bandwidth can be an initial resource bandwidth (e.g., according to an RRC configuration). In this case, a DCI message including an indication for the UE 115 to switch from the BWP 605 to the BWP 610 may include one extra bit to select from these resource bandwidths. This may reduce overhead (e.g., the number of bits for resource bandwidth) signaling for resource bandwidth switching. In the example of FIG. 6, the resource bandwidth 615 and the resource bandwidth 620 may be initial resource bandwidths 640 for the BWP 610.

The UE 115 may, in some examples, be RRC configured with a resource bandwidth switching pattern, such that if the BWP 605 is switched to the BWP 610, the UE 115 may assume a particular resource bandwidth for the BWP 610. The choice of the resource bandwidth in the BWP 610 may depend on a current active BWP, an active resource bandwidth within the BWP 605, the BWP 610 (i.e., a new BWP), or a resource bandwidth within the BWP 610 (i.e., the new BWP), or any combination thereof. The resource bandwidth switching pattern can be a function of a BWP and switching order, for example, from the BWP 605 to the BWP 610 might be different from switching from the BWP 610 to the BWP 605.

The master resource bandwidth may thereby function as a default resource bandwidth for the UE 115 if the UE 115 does not know which resource bandwidth to use for the BWP 610. The master resource bandwidth may also provide flexibility for the UE 115, for example, when switching BWPs from the BWP 605 to the BWP 610 in which the master resource bandwidth may become an active resource bandwidth, unless the UE 115 is explicitly signaled a particular resource bandwidth. The BWP configuration 600 may, as a result, include features for improvements to BWP operations when switching BWPs and, in some examples, may promote high reliability and low latency duplex communications over different BWPs in various systems, such as 4G and 5G systems, among other benefits.

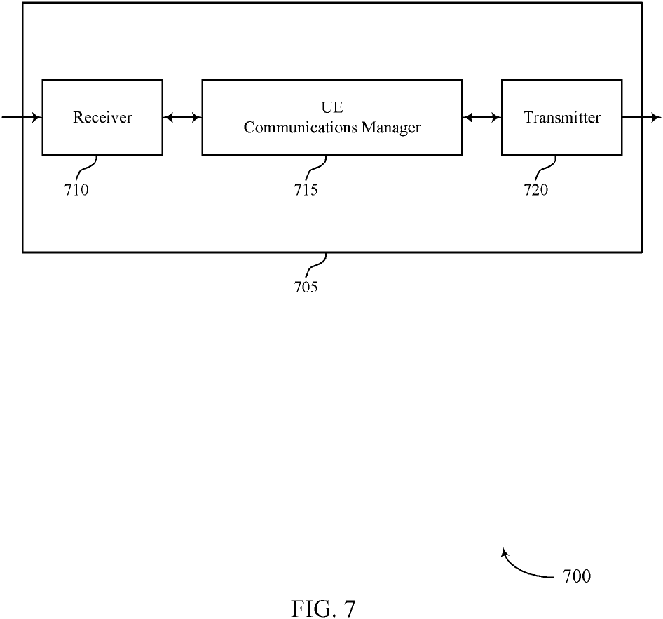

FIG. 7 shows a block diagram 700 of a device 705 that supports duplex communications over BWPs in accordance with aspects of the present disclosure. The device 705 may be an example of aspects of a UE 115 as described herein. The device 705 may include a receiver 710, a UE communications manager 715, and a transmitter 720. The device 705 may also include a processor. Each of these components may be in communication with one another (e.g., via one or more buses).

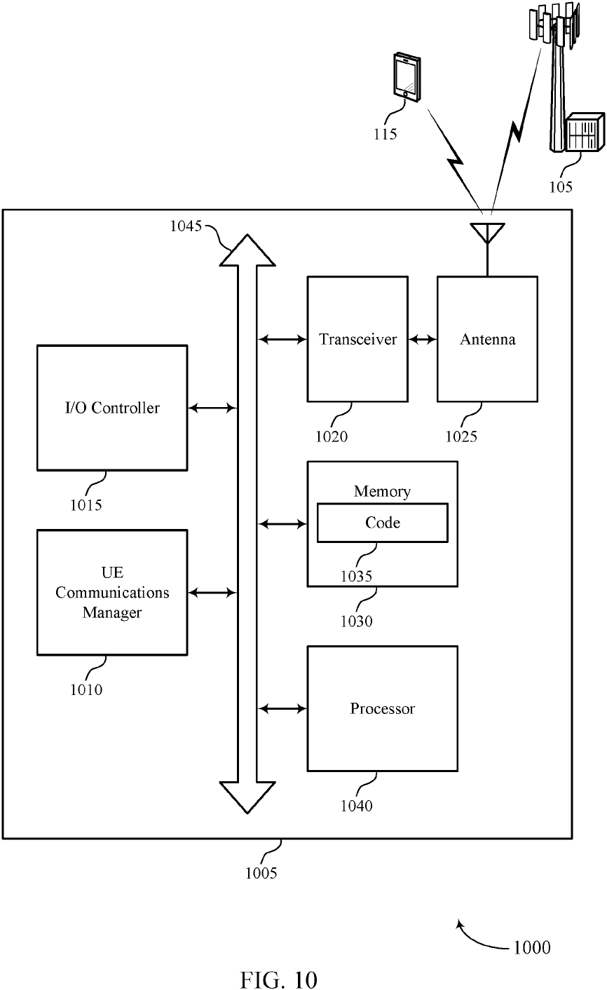

The receiver 710 may receive information such as packets, user data, or control information associated with various information channels (e.g., control channels, data channels, and information related to joint BWP and resource bandwidth indication). Information may be passed on to other components of the device 705. The receiver 710 may be an example of aspects of the transceiver 1020 described with reference to FIG. 10. The receiver 710 may utilize a single antenna or a set of antennas.

The UE communications manager 715 may identify a set of resource bandwidths of a first BWP based on a BWP configuration. The UE communications manager 715 may determine that at least one resource bandwidth of the set of resource bandwidths is a master resource bandwidth. The UE communications manager 715 may communicate with the base station using a resource bandwidth of the set of resource bandwidths for the first BWP based on the determining. The UE communications manager 715 may be an example of aspects of the UE communications manager 1010 described herein.

The UE communications manager 715 may be implemented as an integrated circuit or chipset for a mobile device modem, and the receiver 710 and the transmitter 720 may be implemented as analog components (e.g., amplifiers, filters, antennas) coupled with the mobile device modem to enable wireless transmission and reception. The UE communications manager 715 as described herein may be implemented to realize one or more potential improvements. At least one implementation may enable the UE communications manager 715 to determine a master resource bandwidth. Based on implementing the master resource bandwidth as described herein, one or more processors of the device 705 (e.g., processor(s) controlling or incorporated with the UE communications manager 715) may experience reduce power consumption and promote high reliability and low latency duplex communications (e.g., full-duplex communications), among other benefits.

The UE communications manager 715, or its sub-components, may be implemented in hardware, code (e.g., software or firmware) executed by a processor, or any combination thereof. If implemented in code executed by a processor, the functions of the UE communications manager 715, or its sub-components may be executed by a general-purpose processor, a DSP, an application-specific integrated circuit (ASIC), a field programmable gate array (FPGA) or other programmable logic device, discrete gate or transistor logic, discrete hardware components, or any combination thereof designed to perform the functions described in the present disclosure.

The UE communications manager 715, or its sub-components, may be physically located at various positions, including being distributed such that portions of functions are implemented at different physical locations by one or more physical components. In some examples, the UE communications manager 715, or its sub-components, may be a separate and distinct component in accordance with various aspects of the present disclosure. In some examples, the UE communications manager 715, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 720 may transmit signals generated by other components of the device 705. In some examples, the transmitter 720 may be collocated with a receiver 710 in a transceiver module. For example, the transmitter 720 may be an example of aspects of the transceiver 1020 described with reference to FIG. 10. The transmitter 720 may utilize a single antenna or a set of antennas.

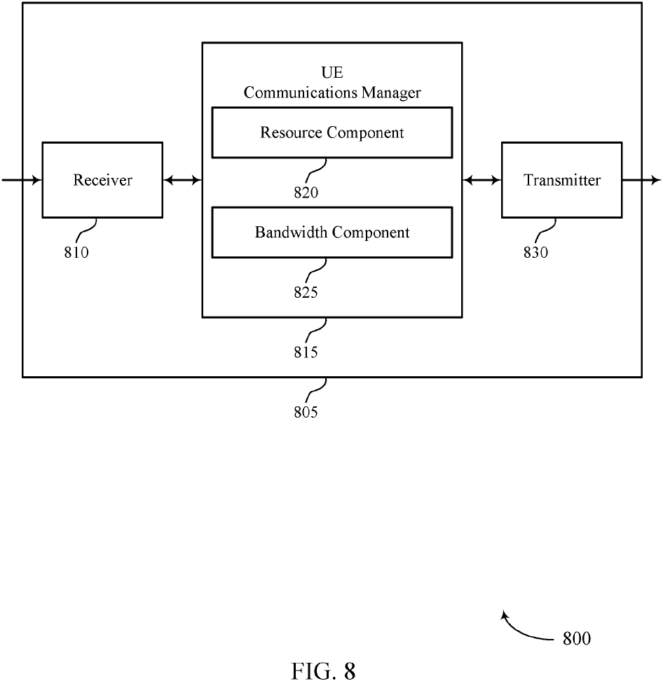

FIG. 8 shows a block diagram 800 of a device 805 that supports duplex communications over BWPs in accordance with aspects of the present disclosure. The device 805 may be an example of aspects of a device 705, or a UE 115 as described herein. The device 805 may include a receiver 810, a UE communications manager 815, and a transmitter 830. The device 805 may also include a processor. Each of these components may be in communication with one another (e.g., via one or more buses).

The receiver 810 may receive information such as packets, user data, or control information associated with various information channels (e.g., control channels, data channels, and information related to joint BWP and resource bandwidth indication). Information may be passed on to other components of the device 805. The receiver 810 may be an example of aspects of the transceiver 1020 described with reference to FIG. 10. The receiver 810 may utilize a single antenna or a set of antennas.

The UE communications manager 815 may be an example of aspects of the UE communications manager 715 as described herein. The UE communications manager 815 may include a resource component 820 and a bandwidth component 825. The UE communications manager 815 may be an example of aspects of the UE communications manager 1010 described herein. The resource component 820 may identify a set of resource bandwidths of a first BWP based on a BWP configuration and determine that at least one resource bandwidth of the set of resource bandwidths is a master resource bandwidth. The bandwidth component 825 may communicate with the base station using a resource bandwidth of the set of resource bandwidths for the first BWP based on the determining.

The transmitter 830 may transmit signals generated by other components of the device 805. In some examples, the transmitter 830 may be collocated with a receiver 810 in a transceiver module. For example, the transmitter 830 may be an example of aspects of the transceiver 1020 described with reference to FIG. 10. The transmitter 830 may utilize a single antenna or a set of antennas.

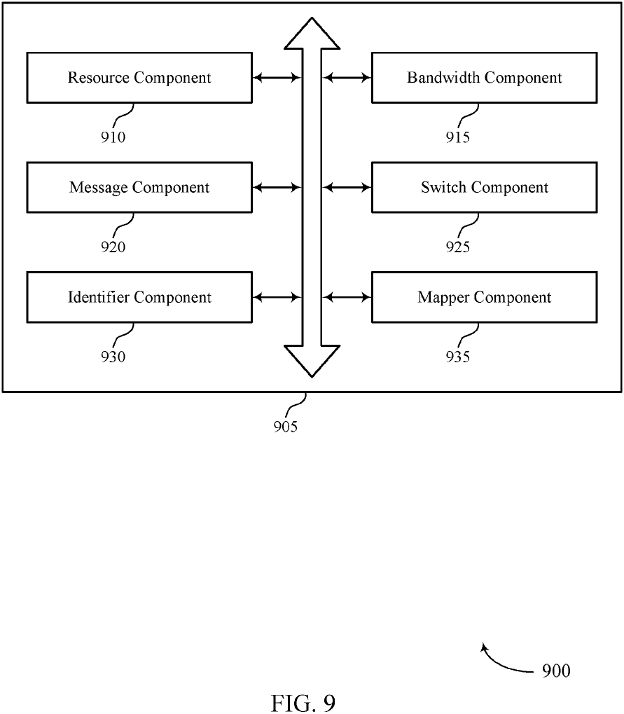

FIG. 9 shows a block diagram 900 of a UE communications manager 905 that supports duplex communications over BWPs in accordance with aspects of the present disclosure. The UE communications manager 905 may be an example of aspects of a UE communications manager 715, a UE communications manager 815, or a UE communications manager 1010 described herein. The UE communications manager 905 may include a resource component 910, a bandwidth component 915, a message component 920, a switch component 925, an identifier component 930, and a mapper component 935. Each of these modules may communicate, directly or indirectly, with one another (e.g., via one or more buses).

The resource component 910 may identify a set of resource bandwidths of a first BWP based on a BWP configuration. In some examples, the resource component 910 may determine that at least one resource bandwidth of the set of resource bandwidths is a master resource bandwidth. In some examples, the resource component 910 may determine that the at least one resource bandwidth of the set of resource bandwidths is the master resource bandwidth by determining that the at least one resource bandwidth corresponds to a smallest resource bandwidth of the set of resource bandwidths. In some examples, the resource component 910 may determine that the at least one resource bandwidth of the set of resource bandwidths is the master resource bandwidth by determining that the at least one resource bandwidth corresponds to a largest resource bandwidth of the set of resource bandwidths.

The resource component 910 may receive a DCI message including a DCI field. In some examples, the resource component 910 may determine one or more bits in the DCI field, and select a subset of resource bandwidths of a second set of resource bandwidths based on the one or more bits in the DCI field. In some examples, the resource component 910 may receive an RRC configuration message including an indication of a resource bandwidth switching pattern. In some cases, the master resource bandwidth overlaps with an uplink band, a guard band, or a downlink band, or any combination thereof.

In some cases, the resource component 910 may select the subset of resource bandwidths of the second set of resource bandwidths associated with a second BWP based on switching from the first BWP to the second BWP, and communicating with the base station includes communicating with the base station using at last one resource bandwidth of the subset of resource bandwidths. The subset of resource bandwidths are initial resource bandwidths for the second BWP. In some cases, the resource component 910 may determine a second active resource bandwidth for the second BWP based on a resource bandwidth switching pattern, where communicating with the base station includes communicating with the base station using the second active resource bandwidth for the second BWP.

The second active resource bandwidth for the second BWP, in some cases, may be based on the first BWP. In some cases, the second active resource bandwidth for the second BWP may be based on a first active resource bandwidth associated with the first BWP. In some cases, the second active resource bandwidth for the second BWP may be based on the second BWP. In some cases, the second active resource bandwidth for the second BWP may be based on the second set of resource bandwidths of the second BWP. In some cases, the resource bandwidth switching pattern may be based on a BWP or a BWP switching order, or both.

The bandwidth component 915 may communicate with the base station using a resource bandwidth of the set of resource bandwidths for the first BWP based on the determining. In some examples, the bandwidth component 915 may communicate with the base station using the master resource bandwidth for the first BWP based on determining that the at least one resource bandwidth of the set of resource bandwidths is the master resource bandwidth, where the resource bandwidth is the master resource bandwidth.

The message component 920 may receive an indication of the master resource bandwidth from the base station, where determining that the at least one resource bandwidth of the set of resource bandwidths is the master resource bandwidth is based on the indication. In some examples, the message component 920 may receive one or more of an RRC message, a DCI message, or a MAC-CE message including the indication of the master resource bandwidth, where determining that the at least one resource bandwidth of the set of resource bandwidths is the master resource bandwidth is based on one or more of the RRC message, the DCI message, or the MAC-CE message including the indication. The switch component 925 may switch from the first BWP to the second BWP for communicating with the base station, where communicating with the base station includes communicating with the base station based on switching to the second BWP. In some examples, the switch component 925 may determine that the master resource bandwidth associated with the first BWP is an active resource bandwidth for the second BWP based on a configuration. In some examples, the switch component 925 may determine an active resource bandwidth for the second BWP based on receiving an indication of the active resource bandwidth for the second BWP. In some examples, the switch component 925 may receive a DCI message from the base station, where switching to the second BWP is based on the DCI message. In some cases, the active resource bandwidth associated with the second BWP is different from the master resource bandwidth associated with the first BWP.

The identifier component 930 may determine a set of bits in a DCI field of the DCI message, where the indication of the active resource bandwidth for the second BWP corresponds to the set of bits in the DCI field, where determining the active resource bandwidth for the second BWP is based on the set of bits in the DCI field of the DCI message. In some examples, the identifier component 930 may determine a BWP identifier associated with the second BWP based on a first subset of bits of the set of bits, where switching to the second BWP is based on the BWP identifier. In some examples, the identifier component 930 may determine a resource bandwidth identifier associated with the active resource bandwidth based on a second subset of bits of the set of bits, where communicating with the base station using the active resource bandwidth for the second BWP is based on the BWP identifier and the resource bandwidth identifier.

The mapper component 935 may map the set of bits to an element in a data structure including a set of BWP identifiers and a set of resource bandwidth identifiers. In some examples, the mapper component 935 may determine a BWP identifier associated with the second BWP and a resource bandwidth identifier associated with the active resource bandwidth for the second BWP based on the mapping. In some examples, the mapper component 935 may receive an RRC configuration message including the data structure, where mapping the set of bits to the element in the data structure is based on the RRC configuration message. The data structure includes a table and the element includes an entry in the table. The entry identifying a BWP identifier or a resource bandwidth identifier, or both.

FIG. 10 shows a diagram of a system 1000 including a device 1005 that supports duplex communications over BWPs in accordance with aspects of the present disclosure. The device 1005 may be an example of or include the components of device 705, device 805, or a UE 115 as described herein. The device 1005 may include components for bi-directional voice and data communications including components for transmitting and receiving communications, including a UE communications manager 1010, an I/O controller 1015, a transceiver 1020, an antenna 1025, memory 1030, and a processor 1040. These components may be in electronic communication via one or more buses (e.g., bus 1045).

The UE communications manager 1010 may identify a set of resource bandwidths of a first BWP based on a BWP configuration. The UE communications manager 1010 may determine that at least one resource bandwidth of the set of resource bandwidths is a master resource bandwidth. The UE communications manager 1010 may communicate with the base station using a resource bandwidth of the set of resource bandwidths for the first BWP based on the determining. The UE communications manager 1010 may effectively implement duplex communications over BWPs. At least one implementation may enable the UE communications manager 1010 to determine a master resource bandwidth. The master resource bandwidth may function as a default resource bandwidth for the device 1005, if the device 1005 does not know which resource bandwidth to use for a BWP. Based on implementing the master resource bandwidth as described herein, one or more processors of the device 1005 (e.g., processor(s) controlling or incorporated with the UE communications manager 1010) may experience reduce power consumption and promote high reliability and low latency duplex communications, among other benefits.

The I/O controller 1015 may manage input and output signals for the device 1005. The I/O controller 1015 may also manage peripherals not integrated into the device 1005. In some cases, the I/O controller 1015 may represent a physical connection or port to an external peripheral. In some cases, the I/O controller 1015 may utilize an operating system such as iOS®, ANDROID®, MS-DOS®, MS-WINDOWS®, OS/2®, UNIX®, LINUX®, or another known operating system. In other cases, the I/O controller 1015 may represent or interact with a modem, a keyboard, a mouse, a touchscreen, or a similar device. In some cases, the I/O controller 1015 may be implemented as part of a processor. In some cases, a user may interact with the device 1005 via the I/O controller 1015 or via hardware components controlled by the I/O controller 1015.

The transceiver 1020 may communicate bi-directionally, via one or more antennas, wired, or wireless links as described above. For example, the transceiver 1020 may represent a wireless transceiver and may communicate bi-directionally with another wireless transceiver. The transceiver 1020 may also include a modem to modulate the packets and provide the modulated packets to the antennas for transmission, and to demodulate packets received from the antennas. In some cases, the device 1005 may include a single antenna 1025. However, in some cases, the device 1005 may have more than one antenna 1025, which may be capable of concurrently transmitting or receiving multiple wireless transmissions.

The memory 1030 may include random-access memory (RAM) and read-only memory (ROM). The memory 1030 may store computer-readable, computer-executable code 1035 including instructions that, when executed, cause the processor 1040 to perform various functions described herein. In some cases, the memory 1030 may contain, among other things, a basic input/output system (BIOS) which may control basic hardware or software operation such as the interaction with peripheral components or devices. The code 1035 may include instructions to implement aspects of the present disclosure, including instructions to support wireless communications. The code 1035 may be stored in a non-transitory computer-readable medium such as system memory or other type of memory. In some cases, the code 1035 may not be directly executable by the processor 1040 but may cause a computer (e.g., when compiled and executed) to perform functions described herein.

The processor 1040 may include an intelligent hardware device, (e.g., a general-purpose processor, a digital signal processor (DSP), a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting joint BWP and resource bandwidth indication).

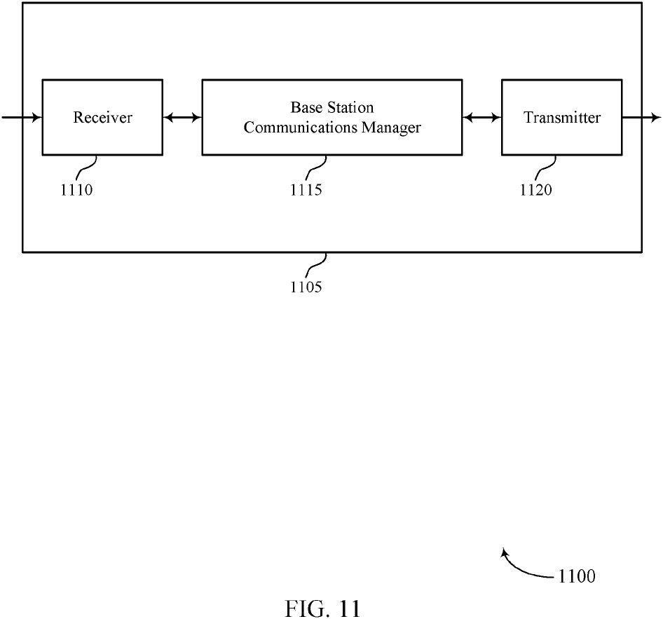

FIG. 11 shows a block diagram 1100 of a device 1105 that supports duplex communications over BWPs in accordance with aspects of the present disclosure. The device 1105 may be an example of aspects of a base station 105 as described herein. The device 1105 may include a receiver 1110, a base station communications manager 1115, and a transmitter 1120. The device 1105 may also include a processor. Each of these components may be in communication with one another (e.g., via one or more buses).

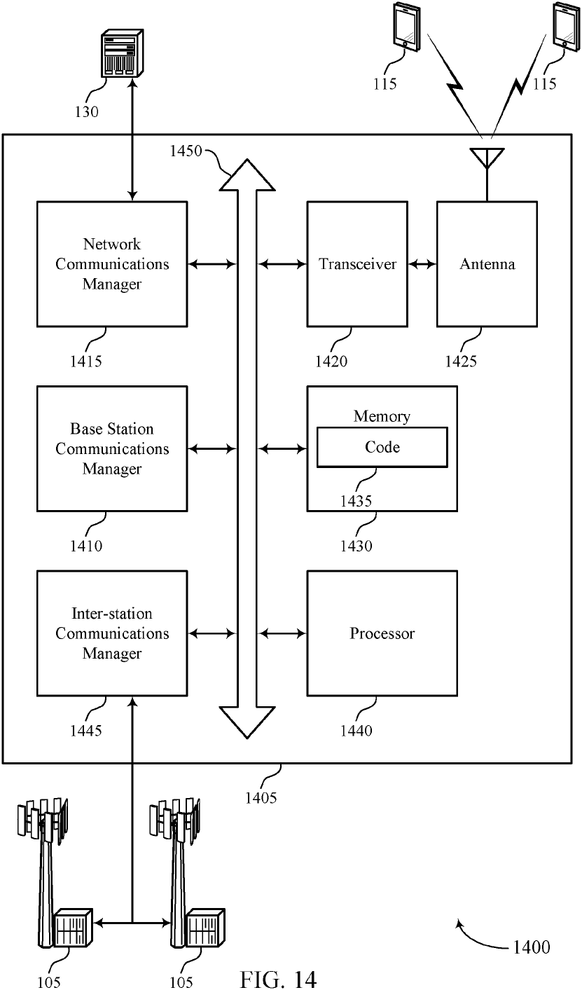

The receiver 1110 may receive information such as packets, user data, or control information associated with various information channels (e.g., control channels, data channels, and information related to joint BWP and resource bandwidth indication). Information may be passed on to other components of the device 1105. The receiver 1110 may be an example of aspects of the transceiver 1420 described with reference to FIG. 14. The receiver 1110 may utilize a single antenna or a set of antennas.

The base station communications manager 1115 may determine a BWP configuration including a set of resource bandwidths of a first BWP, where at least one resource bandwidth of the set of resource bandwidths is a master resource bandwidth for a UE. The base station communications manager 1115 may transmit a message including the BWP configuration to the UE. The base station communications manager 1115 may be an example of aspects of the base station communications manager 1410 described herein.

The base station communications manager 1115, or its sub-components, may be implemented in hardware, code (e.g., software or firmware) executed by a processor, or any combination thereof. If implemented in code executed by a processor, the functions of the base station communications manager 1115, or its sub-components may be executed by a general-purpose processor, a DSP, an ASIC, an FPGA or other programmable logic device, discrete gate or transistor logic, discrete hardware components, or any combination thereof designed to perform the functions described in the present disclosure.

The base station communications manager 1115, or its sub-components, may be physically located at various positions, including being distributed such that portions of functions are implemented at different physical locations by one or more physical components. In some examples, the base station communications manager 1115, or its sub-components, may be a separate and distinct component in accordance with various aspects of the present disclosure. In some examples, the base station communications manager 1115, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 1120 may transmit signals generated by other components of the device 1105. In some examples, the transmitter 1120 may be collocated with a receiver 1110 in a transceiver module. For example, the transmitter 1120 may be an example of aspects of the transceiver 1420 described with reference to FIG. 14. The transmitter 1120 may utilize a single antenna or a set of antennas.

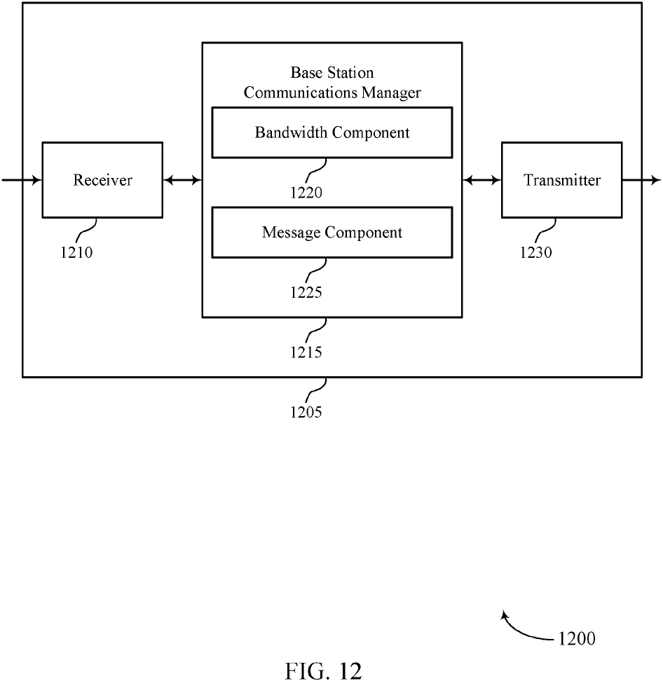

FIG. 12 shows a block diagram 1200 of a device 1205 that supports duplex communications over BWPs in accordance with aspects of the present disclosure. The device 1205 may be an example of aspects of a device 1105, or a base station 105 as described herein. The device 1205 may include a receiver 1210, a base station communications manager 1215, and a transmitter 1230. The device 1205 may also include a processor. Each of these components may be in communication with one another (e.g., via one or more buses).

The receiver 1210 may receive information such as packets, user data, or control information associated with various information channels (e.g., control channels, data channels, and information related to joint BWP and resource bandwidth indication). Information may be passed on to other components of the device 1205. The receiver 1210 may be an example of aspects of the transceiver 1420 described with reference to FIG. 14. The receiver 1210 may utilize a single antenna or a set of antennas.

The base station communications manager 1215 may be an example of aspects of the base station communications manager 1115 as described herein. The base station communications manager 1215 may include a bandwidth component 1220 and a message component 1225. The base station communications manager 1215 may be an example of aspects of the base station communications manager 1410 described herein. The bandwidth component 1220 may determine a BWP configuration including a set of resource bandwidths of a first BWP, where at least one resource bandwidth of the set of resource bandwidths is a master resource bandwidth for a UE. The message component 1225 may transmit a message including the BWP configuration to the UE.

The transmitter 1230 may transmit signals generated by other components of the device 1205. In some examples, the transmitter 1230 may be collocated with a receiver 1210 in a transceiver module. For example, the transmitter 1230 may be an example of aspects of the transceiver 1420 described with reference to FIG. 14. The transmitter 1230 may utilize a single antenna or a set of antennas.

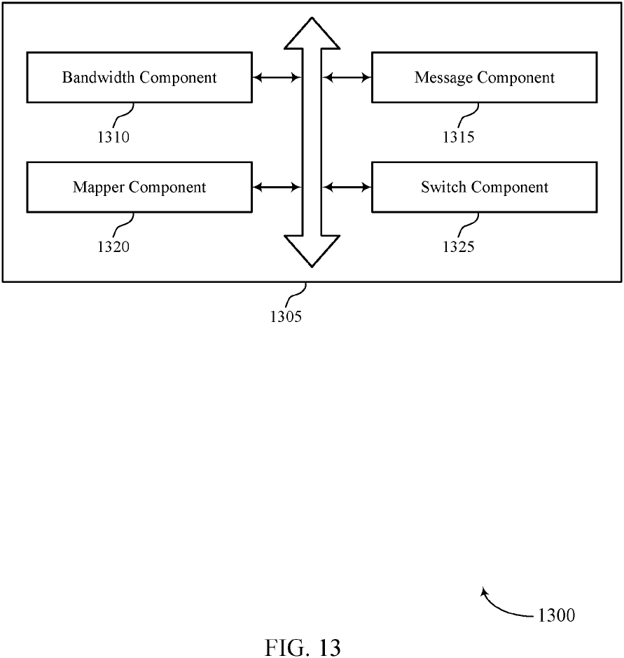

FIG. 13 shows a block diagram 1300 of a base station communications manager 1305 that supports duplex communications over BWPs in accordance with aspects of the present disclosure. The base station communications manager 1305 may be an example of aspects of a base station communications manager 1115, a base station communications manager 1215, or a base station communications manager 1410 described herein. The base station communications manager 1305 may include a bandwidth component 1310, a message component 1315, a mapper component 1320, and a switch component 1325. Each of these modules may communicate, directly or indirectly, with one another (e.g., via one or more buses).

The bandwidth component 1310 may determine a BWP configuration including a set of resource bandwidths of a first BWP, where at least one resource bandwidth of the set of resource bandwidths is a master resource bandwidth for a UE. In some cases, the at least one resource bandwidth corresponds to a smallest resource bandwidth of the set of resource bandwidths. In some cases, the at least one resource bandwidth corresponds to a largest resource bandwidth of the set of resource bandwidths. In some cases, the master resource bandwidth overlaps with an uplink band, a guard band, or a downlink band, or any combination thereof.

The message component 1315 may transmit a message including the BWP configuration to the UE. In some examples, the message component 1315 may transmit an indication of the master resource bandwidth to the UE. In some examples, the message component 1315 may transmit an RRC message including the indication of the master resource bandwidth to the UE. In some examples, the message component 1315 may transmit a DCI message including the indication of the master resource bandwidth to the UE. In some examples, the message component 1315 may transmit a MAC-CE message including the indication of the master resource bandwidth to the UE. In some examples, the message component 1315 may transmit a DCI message to the UE including a command for the UE to switch to a second BWP, where the DCI message includes a set of bits in a DCI field of the DCI message identifying an active resource bandwidth for the second BWP. In some cases, a BWP identifier associated with the second BWP corresponds to a subset of bits of the set of bits. In some cases, a resource bandwidth identifier associated with the active resource bandwidth corresponds to a subset of bits of the set of bits.

The mapper component 1320 may transmit an RRC configuration message including a data structure including a set of BWP identifiers and a set of resource bandwidth identifiers, where the set of bits map to an element in the data structure, the element identifying a BWP identifier or a resource bandwidth identifier, or both. In some cases, the data structure includes a table. The switch component 1325 may transmit an RRC configuration message including an indication of a resource bandwidth switching pattern. In some cases, the resource bandwidth switching pattern is based on a BWP or a BWP switching order, or both.

FIG. 14 shows a diagram of a system 1400 including a device 1405 that supports duplex communications over BWPs in accordance with aspects of the present disclosure. The device 1405 may be an example of or include the components of device 1105, device 1205, or a base station 105 as described herein. The device 1405 may include components for bi-directional voice and data communications including components for transmitting and receiving communications, including a base station communications manager 1410, a network communications manager 1415, a transceiver 1420, an antenna 1425, memory 1430, a processor 1440, and an inter-station communications manager 1445. These components may be in electronic communication via one or more buses (e.g., bus 1450).

The base station communications manager 1410 may determine a BWP configuration including a set of resource bandwidths of a first BWP, where at least one resource bandwidth of the set of resource bandwidths is a master resource bandwidth for a UE. The base station communications manager 1410 may transmit a message including the BWP configuration to the UE.

The network communications manager 1415 may manage communications with the core network (e.g., via one or more wired backhaul links). For example, the network communications manager 1415 may manage the transfer of data communications for client devices, such as one or more UEs 115.

The transceiver 1420 may communicate bi-directionally, via one or more antennas, wired, or wireless links as described above. For example, the transceiver 1420 may represent a wireless transceiver and may communicate bi-directionally with another wireless transceiver. The transceiver 1420 may also include a modem to modulate the packets and provide the modulated packets to the antennas for transmission, and to demodulate packets received from the antennas. In some cases, the device 1405 may include a single antenna 1425. However, in some cases, the device 1405 may have more than one antenna 1425, which may be capable of concurrently transmitting or receiving multiple wireless transmissions.

The memory 1430 may include RAM, ROM, or a combination thereof. The memory 1430 may store computer-readable code 1435 including instructions that, when executed by a processor (e.g., the processor 1440) cause the device to perform various functions described herein. In some cases, the memory 1430 may contain, among other things, a BIOS which may control basic hardware or software operation such as the interaction with peripheral components or devices. The code 1435 may include instructions to implement aspects of the present disclosure, including instructions to support wireless communications. The code 1435 may be stored in a non-transitory computer-readable medium such as system memory or other type of memory. In some cases, the code 1435 may not be directly executable by the processor 1440 but may cause a computer (e.g., when compiled and executed) to perform functions described herein.

The processor 1440 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In some cases, a memory controller may be integrated into processor 1440. The processor 1440 may be configured to execute computer-readable instructions stored in a memory (e.g., the memory 1430) to cause the device 1405 to perform various functions (e.g., functions or tasks supporting joint BWP and resource bandwidth indication).

The inter-station communications manager 1445 may manage communications with other base station 105, and may include a controller or scheduler for controlling communications with UEs 115 in cooperation with other base stations 105. For example, the inter-station communications manager 1445 may coordinate scheduling for transmissions to UEs 115 for various interference mitigation techniques such as beamforming or joint transmission. In some examples, the inter-station communications manager 1445 may provide an X2 interface within an LTE/LTE-A wireless communication network technology to provide communication between base stations 105.

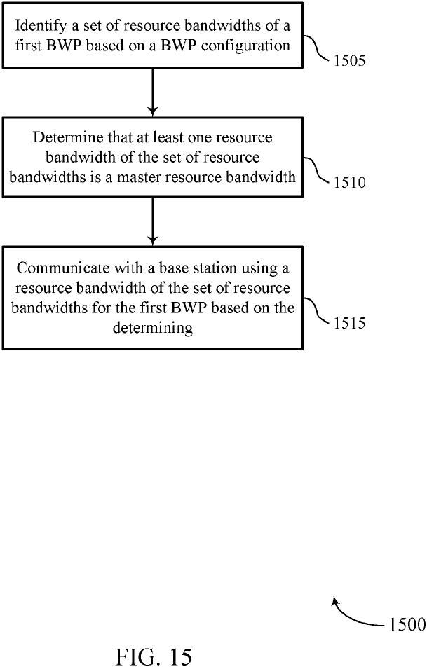

FIG. 15 shows a flowchart illustrating a method 1500 that supports duplex communications over BWPs in accordance with aspects of the present disclosure. The operations of method 1500 may be implemented by a UE 115 or its components as described herein. For example, the operations of method 1500 may be performed by a UE communications manager as described with reference to FIGS. 7 through 10. In some examples, a UE may execute a set of instructions to control the functional elements of the UE to perform the functions described below. Additionally or alternatively, a UE may perform aspects of the functions described below using special-purpose hardware.

At 1505, the UE may identify a set of resource bandwidths of a first BWP based on a BWP configuration. The operations of 1505 may be performed according to the methods described herein. In some examples, aspects of the operations of 1505 may be performed by a resource component as described with reference to FIGS. 7 through 10.

At 1510, the UE may determine that at least one resource bandwidth of the set of resource bandwidths is a master resource bandwidth. The operations of 1510 may be performed according to the methods described herein. In some examples, aspects of the operations of 1510 may be performed by a resource component as described with reference to FIGS. 7 through 10.

At 1515, the UE may communicate with a base station using a resource bandwidth of the set of resource bandwidths for the first BWP based on the determining. The operations of 1515 may be performed according to the methods described herein. In some examples, aspects of the operations of 1515 may be performed by a bandwidth component as described with reference to FIGS. 7 through 10.

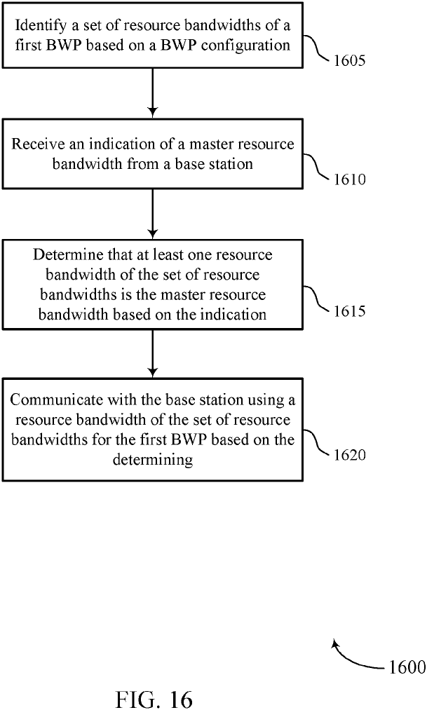

FIG. 16 shows a flowchart illustrating a method 1600 that supports duplex communications over BWPs in accordance with aspects of the present disclosure. The operations of method 1600 may be implemented by a UE 115 or its components as described herein. For example, the operations of method 1600 may be performed by a UE communications manager as described with reference to FIGS. 7 through 10. In some examples, a UE may execute a set of instructions to control the functional elements of the UE to perform the functions described below. Additionally or alternatively, a UE may perform aspects of the functions described below using special-purpose hardware.

At 1605, the UE may identify a set of resource bandwidths of a first BWP based on a BWP configuration. The operations of 1605 may be performed according to the methods described herein. In some examples, aspects of the operations of 1605 may be performed by a resource component as described with reference to FIGS. 7 through 10.

At 1610, the UE may receive an indication of a master resource bandwidth from a base station. The operations of 1610 may be performed according to the methods described herein. In some examples, aspects of the operations of 1610 may be performed by a message component as described with reference to FIGS. 7 through 10.

At 1615, the UE may determine that at least one resource bandwidth of the set of resource bandwidths is the master resource bandwidth based on the indication. The operations of 1615 may be performed according to the methods described herein. In some examples, aspects of the operations of 1615 may be performed by a resource component as described with reference to FIGS. 7 through 10.

At 1620, the UE may communicate with the base station using a resource bandwidth of the set of resource bandwidths for the first BWP based on the determining. The operations of 1620 may be performed according to the methods described herein. In some examples, aspects of the operations of 1620 may be performed by a bandwidth component as described with reference to FIGS. 7 through 10.

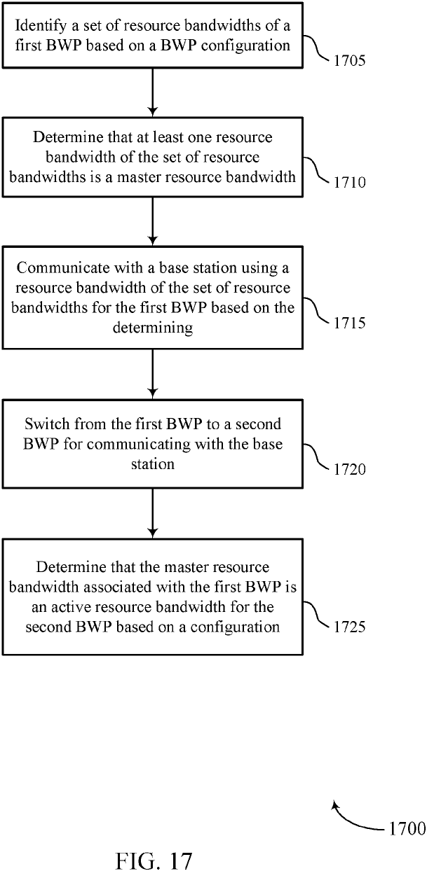

FIG. 17 shows a flowchart illustrating a method 1700 that supports duplex communications over BWPs in accordance with aspects of the present disclosure. The operations of method 1700 may be implemented by a UE 115 or its components as described herein. For example, the operations of method 1700 may be performed by a UE communications manager as described with reference to FIGS. 7 through 10. In some examples, a UE may execute a set of instructions to control the functional elements of the UE to perform the functions described below. Additionally or alternatively, a UE may perform aspects of the functions described below using special-purpose hardware.

At 1705, the UE may identify a set of resource bandwidths of a first BWP based on a BWP configuration. The operations of 1705 may be performed according to the methods described herein. In some examples, aspects of the operations of 1705 may be performed by a resource component as described with reference to FIGS. 7 through 10.

At 1710, the UE may determine that at least one resource bandwidth of the set of resource bandwidths is a master resource bandwidth. The operations of 1710 may be performed according to the methods described herein. In some examples, aspects of the operations of 1710 may be performed by a resource component as described with reference to FIGS. 7 through 10.

At 1715, the UE may communicate with a base station using a resource bandwidth of the set of resource bandwidths for the first BWP based on the determining. The operations of 1715 may be performed according to the methods described herein. In some examples, aspects of the operations of 1715 may be performed by a bandwidth component as described with reference to FIGS. 7 through 10.

At 1720, the UE may switch from the first BWP to a second BWP for communicating with the base station. The operations of 1720 may be performed according to the methods described herein. In some examples, aspects of the operations of 1720 may be performed by a switch component as described with reference to FIGS. 7 through 10.

At 1725, the UE may determine that the master resource bandwidth associated with the first BWP is an active resource bandwidth for the second BWP based on a configuration. The operations of 1725 may be performed according to the methods described herein. In some examples, aspects of the operations of 1725 may be performed by a switch component as described with reference to FIGS. 7 through 10.

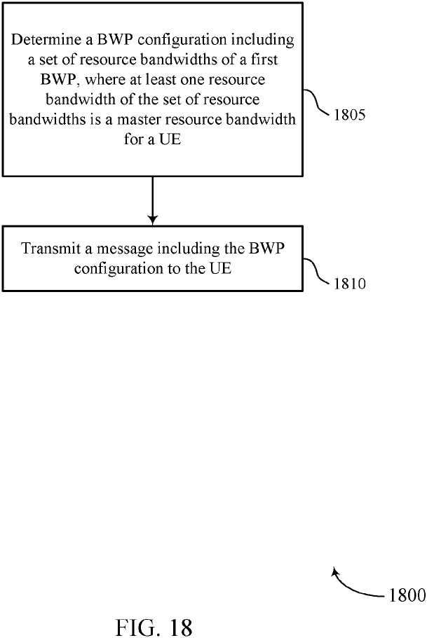

FIG. 18 shows a flowchart illustrating a method 1800 that supports duplex communications over BWPs in accordance with aspects of the present disclosure. The operations of method 1800 may be implemented by a base station 105 or its components as described herein. For example, the operations of method 1800 may be performed by a base station communications manager as described with reference to FIGS. 11 through 14. In some examples, a base station may execute a set of instructions to control the functional elements of the base station to perform the functions described below. Additionally or alternatively, a base station may perform aspects of the functions described below using special-purpose hardware.

At 1805, the base station may determine a BWP configuration including a set of resource bandwidths of a first BWP, where at least one resource bandwidth of the set of resource bandwidths is a master resource bandwidth for a UE. The operations of 1805 may be performed according to the methods described herein. In some examples, aspects of the operations of 1805 may be performed by a bandwidth component as described with reference to FIGS. 11 through 14.

At 1810, the base station may transmit a message including the BWP configuration to the UE. The operations of 1810 may be performed according to the methods described herein. In some examples, aspects of the operations of 1810 may be performed by a message component as described with reference to FIGS. 11 through 14.

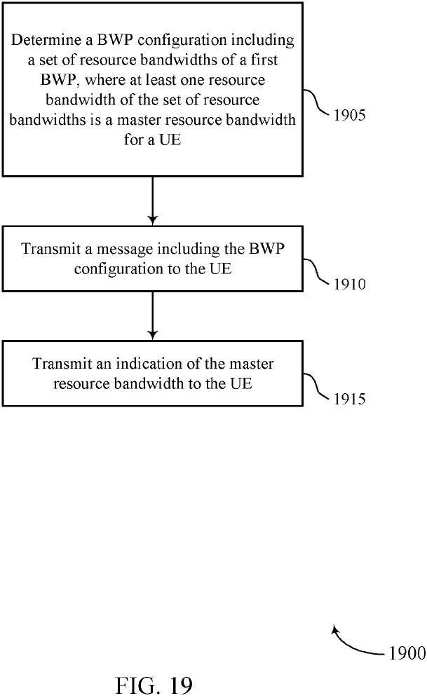

FIG. 19 shows a flowchart illustrating a method 1900 that supports duplex communications over BWPs in accordance with aspects of the present disclosure. The operations of method 1900 may be implemented by a base station 105 or its components as described herein. For example, the operations of method 1900 may be performed by a base station communications manager as described with reference to FIGS. 11 through 14. In some examples, a base station may execute a set of instructions to control the functional elements of the base station to perform the functions described below. Additionally or alternatively, a base station may perform aspects of the functions described below using special-purpose hardware.

At 1905, the base station may determine a BWP configuration including a set of resource bandwidths of a first BWP, where at least one resource bandwidth of the set of resource bandwidths is a master resource bandwidth. The operations of 1905 may be performed according to the methods described herein. In some examples, aspects of the operations of 1905 may be performed by a bandwidth component as described with reference to FIGS. 11 through 14.

At 1910, the base station may transmit a message including the BWP configuration to the UE. The operations of 1910 may be performed according to the methods described herein. In some examples, aspects of the operations of 1910 may be performed by a message component as described with reference to FIGS. 11 through 14.

At 1915, the base station may transmit an indication of the master resource bandwidth to the UE. The operations of 1915 may be performed according to the methods described herein. In some examples, aspects of the operations of 1915 may be performed by a message component as described with reference to FIGS. 11 through 14.

It should be noted that the methods described herein describe possible implementations, and that the operations and the steps may be rearranged or otherwise modified and that other implementations are possible. Further, aspects from two or more of the methods may be combined.

The following provides an overview of aspects of the present disclosure:

Aspect 1: A method for wireless communication at a UE, comprising: identifying a set of resource bandwidths of a first BWP based at least in part on a BWP configuration; determining that at least one resource bandwidth of the set of resource bandwidths is a master resource bandwidth; and communicating with a base station using a resource bandwidth of the set of resource bandwidths for the first BWP based at least in part on the determining.

Aspect 2: The method of aspect 1, wherein communicating with the base station comprises: communicating with the base station using the master resource bandwidth for the first BWP based at least in part on determining that the at least one resource bandwidth of the set of resource bandwidths is the master resource bandwidth, wherein the resource bandwidth is the master resource bandwidth.

Aspect 3: The method of any of aspects 1 through 2, further comprising: receiving an indication of the master resource bandwidth from the base station, wherein determining that the at least one resource bandwidth of the set of resource bandwidths is the master resource bandwidth is based at least in part on the indication.

Aspect 4: The method of aspect 3, wherein the receiving comprises: receiving one or more of an RRC message, a DCI message, or a MAC-CE message comprising the indication of the master resource bandwidth, wherein determining that the at least one resource bandwidth of the set of resource bandwidths is the master resource bandwidth is based at least in part on one or more of the RRC message, the DCI message, or the MAC-CE message comprising the indication.

Aspect 5: The method of any of aspects 1 through 4, wherein determining that the at least one resource bandwidth of the set of resource bandwidths is the master resource bandwidth comprises: determining that the at least one resource bandwidth corresponds to a smallest resource bandwidth of the set of resource bandwidths.

Aspect 6: The method of any of aspects 1 through 5, wherein determining that the at least one resource bandwidth of the set of resource bandwidths is the master resource bandwidth comprises: determining that the at least one resource bandwidth corresponds to a largest resource bandwidth of the set of resource bandwidths.

Aspect 7: The method of any of aspects 1 through 6, wherein the master resource bandwidth overlaps with an uplink band, a guard band, or a downlink band, or any combination thereof.

Aspect 8: The method of any of aspects 1 through 7, further comprising: switching from the first BWP to a second BWP for communicating with the base station, wherein communicating with the base station comprises communicating with the base station based at least in part on switching to the second BWP.

Aspect 9: The method of aspect 8, further comprising: determining that the master resource bandwidth associated with the first BWP is an active resource bandwidth for the second BWP based at least in part on a configuration, wherein communicating with the base station comprises; and communicating with the base station using the active resource bandwidth for the second BWP.

Aspect 10: The method of any of aspects 8 through 9, further comprising: determining an active resource bandwidth for the second BWP based at least in part on receiving an indication of the active resource bandwidth for the second BWP, wherein communicating with the base station comprises; and communicating with the base station using the active resource bandwidth for the second BWP.

Aspect 11: The method of aspect 10, wherein the active resource bandwidth associated with the second BWP is different from the master resource bandwidth associated with the first BWP.

Aspect 12: The method of any of aspects 10 through 11, further comprising: receiving a DCI message from the base station, wherein switching to the second BWP is based at least in part on the DCI message.

Aspect 13: The method of aspect 12, further comprising: determining a set of bits in a DCI field of the DCI message, wherein the indication of the active resource bandwidth for the second BWP corresponds to the set of bits in the DCI field, wherein determining the active resource bandwidth for the second BWP is based at least in part on the set of bits in the DCI field of the DCI message.

Aspect 14: The method of aspect 13, further comprising: determining a BWP identifier associated with the second BWP based at least in part on a first subset of bits of the set of bits, wherein switching to the second BWP is based at least in part on the BWP identifier; and determining a resource bandwidth identifier associated with the active resource bandwidth based at least in part on a second subset of bits of the set of bits, wherein communicating with the base station using the active resource bandwidth for the second BWP is based at least in part on the BWP identifier and the resource bandwidth identifier.

Aspect 15: The method of any of aspects 12 through 14, further comprising: mapping the set of bits to an element in a data structure comprising a set of BWP identifiers and a set of resource bandwidth identifiers; and determining a BWP identifier associated with the second BWP and a resource bandwidth identifier associated with the active resource bandwidth for the second BWP based at least in part on the mapping.

Aspect 16: The method of aspect 15, further comprising: receiving an RRC configuration message including the data structure, wherein mapping the set of bits to the element in the data structure is based at least in part on the RRC configuration message, wherein the data structure comprises a table and the element comprises an entry in the table, the entry identifying a BWP identifier or a resource bandwidth identifier, or both.

Aspect 17: The method of any of aspects 10 through 16, wherein selecting a subset of resource bandwidths of a second set of resource bandwidths associated with the second BWP based at least in part on the switching, wherein communicating with the base station comprises: communicating with the base station using at last one resource bandwidth of the subset of resource bandwidths, wherein the subset of resource bandwidths are initial resource bandwidths for the second BWP.

Aspect 18: The method of aspect 17, further comprising: receiving a DCI message comprising a DCI field; and determining one or more bits in the DCI field, wherein selecting the subset of resource bandwidths of the second set of resource bandwidths is based at least in part on the one or more bits in the DCI field.

Aspect 19: The method of any of aspects 8 through 18, wherein determining a second active resource bandwidth for the second BWP based at least in part on a resource bandwidth switching pattern, wherein communicating with the base station comprises: communicating with the base station using the second active resource bandwidth for the second BWP.

Aspect 20: The method of aspect 19, further comprising: receiving an RRC configuration message comprising an indication of the resource bandwidth switching pattern, wherein the resource bandwidth switching pattern is based at least in part on a BWP or a BWP switching order, or both.

Aspect 21: The method of any of aspects 19 through 20, wherein the second active resource bandwidth for the second BWP is based at least in part on the first BWP, a first active resource bandwidth associated with the first BWP, the second BWP, a second set of resource bandwidths of the second BWP, or any combination thereof.

Aspect 22: A method for wireless communication at a base station, comprising: determining a BWP configuration comprising a set of resource bandwidths of a first BWP, wherein at least one resource bandwidth of the set of resource bandwidths is a master resource bandwidth for a UE; and transmitting a message comprising the BWP configuration to the UE.

Aspect 23: The method of aspect 22, further comprising: transmitting one or more of an RRC message, a DCI message, or a MAC-CE message comprising an indication of the master resource bandwidth to the UE, wherein the master resource bandwidth overlaps with an uplink band, a guard band, or a downlink band, or any combination thereof.

Aspect 24: The method of any of aspects 22 through 23, wherein the at least one resource bandwidth corresponds to a smallest resource bandwidth of the set of resource bandwidths or to a largest resource bandwidth of the set of resource bandwidths.

Aspect 25: The method of any of aspects 22 through 24, further comprising: transmitting a DCI message to the UE comprising a command for the UE to switch to a second BWP, wherein the DCI message comprises a set of bits in a DCI field of the DCI message identifying an active resource bandwidth for the second BWP.

Aspect 26: The method of aspect 25, wherein a BWP identifier associated with the second BWP corresponds to a subset of bits of the set of bits, or a resource bandwidth identifier associated with the active resource bandwidth corresponds to the subset of bits of the set of bits.

Aspect 27: The method of any of aspects 25 through 26, further comprising: transmitting an RRC configuration message including a data structure comprising a set of BWP identifiers and a set of resource bandwidth identifiers, wherein the set of bits map to an element in the data structure, the element identifying a BWP identifier or a resource bandwidth identifier, or both, wherein the data structure comprises a table.

Aspect 28: The method of any of aspects 22 through 27, further comprising: transmitting an RRC configuration message comprising an indication of a resource bandwidth switching pattern, wherein the resource bandwidth switching pattern is based at least in part on a BWP or a BWP switching order, or both.

Aspect 29: An apparatus for wireless communication at a UE, comprising a processor; memory coupled with the processor; and instructions stored in the memory and executable by the processor to cause the apparatus to perform a method of any of aspects 1 through 21.

Aspect 30: An apparatus for wireless communication at a UE, comprising at least one means for performing a method of any of aspects 1 through 21.

Aspect 31: A non-transitory computer-readable medium storing code for wireless communication at a UE, the code comprising instructions executable by a processor to perform a method of any of aspects 1 through 21.

Aspect 32: An apparatus for wireless communication at a base station, comprising a processor; memory coupled with the processor; and instructions stored in the memory and executable by the processor to cause the apparatus to perform a method of any of aspects 22 through 28.

Aspect 33: An apparatus for wireless communication at a base station, comprising at least one means for performing a method of any of aspects 22 through 28.

Aspect 34: A non-transitory computer-readable medium storing code for wireless communication at a base station, the code comprising instructions executable by a processor to perform a method of any of aspects 22 through 28.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication at a user equipment (UE), comprising:
identifying a set of resource bandwidths of a first bandwidth part based at least in part on a bandwidth part configuration;
determining that at least one resource bandwidth of the set of resource bandwidths is a master resource bandwidth; and
communicating with a base station using a resource bandwidth of the set of resource bandwidths for the first bandwidth part based at least in part on the determining.

2. The method of claim 1, wherein communicating with the base station comprises:
communicating with the base station using the master resource bandwidth for the first bandwidth part based at least in part on determining that the at least one resource bandwidth of the set of resource bandwidths is the master resource bandwidth, wherein the resource bandwidth is the master resource bandwidth.

3. The method of claim 1, further comprising:
receiving an indication of the master resource bandwidth from the base station,
wherein determining that the at least one resource bandwidth of the set of resource bandwidths is the master resource bandwidth is based at least in part on the indication.

4. The method of claim 3, wherein the receiving comprises:
receiving one or more of a radio resource control message, a downlink control information message, or a medium access control-control element message comprising the indication of the master resource bandwidth,
wherein determining that the at least one resource bandwidth of the set of resource bandwidths is the master resource bandwidth is based at least in part on one or more of the radio resource control message, the downlink control information message, or the medium access control-control element message comprising the indication.

5. The method of claim 1, wherein determining that the at least one resource bandwidth of the set of resource bandwidths is the master resource bandwidth comprises:
determining that the at least one resource bandwidth corresponds to a smallest resource bandwidth of the set of resource bandwidths.

6. The method of claim 1, wherein determining that the at least one resource bandwidth of the set of resource bandwidths is the master resource bandwidth comprises:
determining that the at least one resource bandwidth corresponds to a largest resource bandwidth of the set of resource bandwidths.

7. The method of claim 1, wherein the master resource bandwidth overlaps with an uplink band, a guard band, or a downlink band, or any combination thereof.

8. The method of claim 1, further comprising:
switching from the first bandwidth part to a second bandwidth part for communicating with the base station, wherein communicating with the base station comprises communicating with the base station based at least in part on switching to the second bandwidth part.

9. The method of claim 8, further comprising:
determining that the master resource bandwidth associated with the first bandwidth part is an active resource bandwidth for the second bandwidth part based at least in part on a configuration, wherein communicating with the base station comprises; and
communicating with the base station using the active resource bandwidth for the second bandwidth part.

10. The method of claim 8, further comprising:
determining an active resource bandwidth for the second bandwidth part based at least in part on receiving an indication of the active resource bandwidth for the second bandwidth part, wherein communicating with the base station comprises; and
communicating with the base station using the active resource bandwidth for the second bandwidth part.

11. The method of claim 10, wherein the active resource bandwidth associated with the second bandwidth part is different from the master resource bandwidth associated with the first bandwidth part.

12. The method of claim 10, further comprising:
receiving a downlink control information message from the base station, wherein switching to the second bandwidth part is based at least in part on the downlink control information message.

13. The method of claim 12, further comprising:
determining a set of bits in a downlink control information field of the downlink control information message, wherein the indication of the active resource bandwidth for the second bandwidth part corresponds to the set of bits in the downlink control information field,
wherein determining the active resource bandwidth for the second bandwidth part is based at least in part on the set of bits in the downlink control information field of the downlink control information message.

14. The method of claim 13, further comprising:
determining a bandwidth part identifier associated with the second bandwidth part based at least in part on a first subset of bits of the set of bits, wherein switching to the second bandwidth part is based at least in part on the bandwidth part identifier; and
determining a resource bandwidth identifier associated with the active resource bandwidth based at least in part on a second subset of bits of the set of bits,
wherein communicating with the base station using the active resource bandwidth for the second bandwidth part is based at least in part on the bandwidth part identifier and the resource bandwidth identifier.

15. The method of claim 12, further comprising:
mapping the set of bits to an element in a data structure comprising a set of bandwidth part identifiers and a set of resource bandwidth identifiers; and
determining a bandwidth part identifier associated with the second bandwidth part and a resource bandwidth identifier associated with the active resource bandwidth for the second bandwidth part based at least in part on the mapping.

16. The method of claim 15, further comprising:
receiving a radio resource control configuration message including the data structure, wherein mapping the set of bits to the element in the data structure is based at least in part on the radio resource control configuration message, wherein the data structure comprises a table and the element comprises an entry in the table, the entry identifying a bandwidth part identifier or a resource bandwidth identifier, or both.

17. The method of claim 10, wherein selecting a subset of resource bandwidths of a second set of resource bandwidths associated with the second bandwidth part based at least in part on the switching, wherein communicating with the base station comprises:
communicating with the base station using at last one resource bandwidth of the subset of resource bandwidths, wherein the subset of resource bandwidths are initial resource bandwidths for the second bandwidth part.

18. The method of claim 17, further comprising:
receiving a downlink control information message comprising a downlink control information field; and
determining one or more bits in the downlink control information field, wherein selecting the subset of resource bandwidths of the second set of resource bandwidths is based at least in part on the one or more bits in the downlink control information field.

19. The method of claim 8, wherein determining a second active resource bandwidth for the second bandwidth part based at least in part on a resource bandwidth switching pattern, wherein communicating with the base station comprises:
communicating with the base station using the second active resource bandwidth for the second bandwidth part.

20. The method of claim 19, further comprising:
receiving a radio resource control configuration message comprising an indication of the resource bandwidth switching pattern, wherein the resource bandwidth switching pattern is based at least in part on a bandwidth part or a bandwidth part switching order, or both.

21. The method of claim 19, wherein the second active resource bandwidth for the second bandwidth part is based at least in part on the first bandwidth part, a first active resource bandwidth associated with the first bandwidth part, the second bandwidth part, a second set of resource bandwidths of the second bandwidth part, or any combination thereof.

22. A method for wireless communication at a base station, comprising:
determining a bandwidth part configuration comprising a set of resource bandwidths of a first bandwidth part, wherein at least one resource bandwidth of the set of resource bandwidths is a master resource bandwidth for a user equipment (UE); and
transmitting a message comprising the bandwidth part configuration to the UE.

23. The method of claim 22, further comprising:
transmitting one or more of a radio resource control message, a downlink control information message, or a medium access control-control element message comprising an indication of the master resource bandwidth to the UE,
wherein the master resource bandwidth overlaps with an uplink band, a guard band, or a downlink band, or any combination thereof.

24. The method of claim 22, wherein the at least one resource bandwidth corresponds to a smallest resource bandwidth of the set of resource bandwidths or to a largest resource bandwidth of the set of resource bandwidths.

25. The method of claim 22, further comprising:
transmitting a downlink control information message to the UE comprising a command for the UE to switch to a second bandwidth part,
wherein the downlink control information message comprises a set of bits in a downlink control information field of the downlink control information message identifying an active resource bandwidth for the second bandwidth part.

26. The method of claim 25, wherein a bandwidth part identifier associated with the second bandwidth part corresponds to a subset of bits of the set of bits, or a resource bandwidth identifier associated with the active resource bandwidth corresponds to the subset of bits of the set of bits.

27. The method of claim 25, further comprising:
transmitting a radio resource control configuration message including a data structure comprising a set of bandwidth part identifiers and a set of resource bandwidth identifiers, wherein the set of bits map to an element in the data structure, the element identifying a bandwidth part identifier or a resource bandwidth identifier, or both, wherein the data structure comprises a table.

28. The method of claim 22, further comprising:
transmitting a radio resource control configuration message comprising an indication of a resource bandwidth switching pattern, wherein the resource bandwidth switching pattern is based at least in part on a bandwidth part or a bandwidth part switching order, or both.

29. An apparatus for wireless communication, comprising:
a processor,
memory coupled with the processor; and
instructions stored in the memory and executable by the processor to cause the apparatus to:
identify a set of resource bandwidths of a first bandwidth part based at least in part on a bandwidth part configuration;
determine that at least one resource bandwidth of the set of resource bandwidths is a master resource bandwidth; and
communicate with a base station using a resource bandwidth of the set of resource bandwidths for the first bandwidth part based at least in part on the determining.

30. An apparatus for wireless communication, comprising:
a processor,
memory coupled with the processor; and
instructions stored in the memory and executable by the processor to cause the apparatus to:
determine a bandwidth part configuration comprising a set of resource bandwidths of a first bandwidth part, wherein at least one resource bandwidth of the set of resource bandwidths is a master resource bandwidth for a user equipment (UE); and
transmit a message comprising the bandwidth part configuration to the UE.
